(19) United States
(12) Patent Application Publication
(10) Pub. No.: US 2024/0376793 A1
(43) Pub. Date: Nov. 14, 2024

(54) SYSTEM AND METHOD OF USING OSCILLATOR TO CREATE PULSING WAVES

(71) Applicant: GTherm Energy, Inc., Houston, TX (US)

(72) Inventors: Michael J. Parrella, Katy, TX (US); Jonathan Parrella, Fulshear, TX (US); Daniel Parrella, Katy, TX (US)

(21) Appl. No.: 18/696,461

(22) PCT Filed: Sep. 28, 2022
(86) PCT No.: PCT/US2022/045009

§ 371 Date: Mar. 28, 2024

Related U.S. Application Data
(60) Provisional application No. 63/370,448, filed on Aug. 4, 2022.
(60) Provisional application No. 63/249,441, filed on Sep. 28, 2021.

(51) Int. Cl. E21B 28/00; F16K 5/12; F16K 31/04

(52) U.S. Cl. CPC E21B 28/00; F16K 5/12; F16K 31/042; E21B 2200/04

(57) ABSTRACT

An oscillation apparatus, system, and method are provided for creating pulsing pressure waves in a fluid flow that can be used to open and close flow paths for fluid flow in a reservoir, mixing a fluid, or keeping a particulate suspension homogenous in a fluid. The system includes an oscillation apparatus including a motor and an oscillating valve that rotates at a particular speed and frequency while a pump circulates a fluid through the oscillation apparatus, which outputs the fluid in a pulsing wave. The apparatus or system may further include one or more sensors and a control system that control the speed and the frequency of the rotation of the oscillating valve.

### CROSS-REFERENCE TO RELATED APPLICATIONS

The present application claims the benefit of U.S. Provisional Patent Application 63/249,441 filed Sep. 28, 2021 and U.S. Provisional Patent Application 63/370,448 filed Aug. 4, 2022, which is hereby incorporated by reference in its entirety.

### FIELD OF THE APPLICATION

The present application relates to an oscillator system to create pulsing pressure waves in a fluid flow, and applications for the use thereof.

### BACKGROUND OF THE DISCLOSURE

As discussed in U.S. Pat. No. 10,267,128, excitation of an oil reservoir with a pressure wave results in a repeating pattern of high-pressure and low-pressure regions moving through the oil reservoir, which enhances oil recovery by causing movement in the walls of a pore of a particle of rock, so as to induce movement and flow of oil, gas and water out of the pore. It also breaks the surface tension of the capillaries in the rock pore. To cause pressure waves characterized by cycles of low and high pressure, pumps or other forms of transducers may be used, as will be described further herein. The length of one cycle (i.e., the wavelength) and the number of times the cycle repeats itself per unit time defines the frequency of the pressure wave. The velocity of the wave depends on the medium but is defined as the frequency times the wavelength.

FIG. 1A shows a longitudinal sound wave propagating in air and having a sinusoidal form with pressure peaks and troughs shown in relation to atmospheric pressure. FIG. 1B is in alignment with FIG. 1A to show the wave of FIG. 1A causing air particle displacement parallel to the direction of propagation, left to right in the Figure, with rarefactions and compressions of air molecules corresponding to the decreased pressure and increased pressure, respectively, as compared to atmospheric pressure in FIG. 1A. FIGS. 1A and 1B show an example of a longitudinal sound wave produced in air, for example, by a vibrating tuning fork. A wave is a disturbance or variation that travels through a medium. The medium in the example of FIGS. 1A and 1B is air through which the disturbance or sound or pressure wave travels. The pressure of a sinusoidal pressure wave is shown plotted versus time in FIG. 1A propagating 10 from left to right. If FIGS. 1A and 1B were animated, the impression would be that the regions of compression travel from left to right. In reality, although the air molecules experience some local oscillations as the pressure wave passes, the molecules do not travel with the wave. As the tines of the fork vibrate back and forth, they push on neighboring air molecules. The forward motion of a tine pushes air molecules horizontally to the right to create a high-pressure area and the backward retraction of the tine to the left creates a low-pressure area allowing the air molecules to move back to the left. As shown in the plot of displacement in the bottom half in FIG. 1B, because of the longitudinal motion 11 of the air molecules, there are regions where the air molecules are compressed together and other regions where the air molecules are spread apart. These regions are known as compressions and rarefactions, respectively. The compressions are regions of high air pressure, and the rarefactions are regions of low air pressure. At the far left of FIG. 1B, an increased pressure compression is depicted corresponding to a peak 12 in FIG. 1A, following an up amplitude 13. A decreased pressure rarefaction corresponding to a trough 14 then follows down amplitudes 15 and 16. The maximum distance (the crest or trough) that a molecule of the air moves away from its rest position, indicated by horizontal line 17 in FIG. 1A, is the amplitude. As such, this may be understood as the amplitude of the movement of an air molecule caused by the pressure wave as it propagates through the air. The sinusoid in FIG. 1A represents the extremes of the horizontal molecule displacement amplitude of the air molecules as the pressure wave moves. It may also be seen as representative of the pressure amplitude of the wave as it propagates through the air. The wavelength 18 of such a wave is the distance that the wave travels in the air in one complete wave cycle. The wavelength is commonly measured as the distance from one compression to the next adjacent compression or the distance from one rarefaction to the next adjacent rarefaction.

Wave interference is the phenomenon that occurs when two waves meet while traveling along the same medium. The interference of waves causes the medium to take on a shape that results from the net effect of the two individual waves upon the particles of the medium. Consider two pulses of the same amplitude traveling in different directions along the same medium. Each pulse is displaced upward one unit at its crest and has the shape of a sine wave. As the sine waves move towards each other, there will eventually be a moment in time when the waves completely overlap. At that moment, the resulting shape of the medium would be an upward displaced sine pulse with amplitude of two units. This is constructive interference as shown in FIG. 1D. On the other hand, FIG. 1C depicts the results when two equal waves meet that are 180° out of phase. When the two out of phase waves meet, the compression and rarefactions overlay and the resultant wave has zero compression and rarefaction, as the waves cancel each other with destructive interference. If two waves meet in-phase, the compression is additive and the rarefaction is additive, as in FIG. 1D.

Excitation of an oil reservoir with a pressure wave results in a repeating pattern of high-pressure and low-pressure regions moving through the oil reservoir, which enhances oil recovery by causing movement in the walls of a pore of a particle of rock, so as to induce movement and flow of oil, gas, and water out of the pore. It also breaks the surface tension of the capillaries in the rock pore. To cause pressure waves characterized by cycles of low and high pressure, pumps or other forms of transducers may be used. The length of one cycle (i.e., the wavelength) and the number of times the cycle repeats itself per unit time defines the frequency of the pressure wave. The velocity of the wave depends on the medium but is defined as the frequency times the wavelength.

Constructive wave interference, such as shown in FIG. 1D, can be used to enhance oil and gas recovery by increasing the flow of oil and gas in a reservoir, as discussed in U.S. Pat. No. 10,267,128. However, improved systems and devices for generating constructive waves, which may have additional applications, can be provided over the prior art, including those described in U.S. Pat. No. 10,267,128.

### SUMMARY OF THE DISCLOSURE

The present application relates to a system, apparatus and method for creating and using one or more oscillators to create pulsing pressure waves in a fluid flow, and for creating an oscillator(s) that are used to open and close flow paths (pipes) for fluid flow. By using one or more oscillators, such as a redesigned ball valve, oscillations are created by rotating the valve at an RPM (revolutions per minute) that creates the frequency of the wave. The magnitude of the wave is created by the pressure of the fluid.

In accordance with a first aspect of the present application an apparatus is provided. The apparatus comprises a housing, which comprises an inlet port, an outlet port, and a chamber disposed in between the inlet port and the outlet port. The apparatus also comprises an oscillating valve comprising a valve body arranged inside of the chamber having an opening passing therethrough. The apparatus further comprises an electric motor configured to rotate the oscillating valve in between a first alignment in which the opening through the valve body is aligned with and open between the inlet port and the outlet port of the housing, and a second alignment in which the opening through the valve body is not open to the inlet port and the outlet port of the housing. The oscillating valve is configured to allow a maximum fluid flow level through the apparatus when in the first alignment, a minimum fluid flow level through the apparatus when in the second alignment, and intermediate fluid flow levels when in between the first alignment and the second alignment. Rotation or oscillation between the first alignment and the second alignment creates pressure waves of fluid passing through the apparatus.

In accordance with embodiments of the apparatus of the first aspect of the application, the housing may include a first housing member having the inlet port, and a second housing member having the outlet port, and the first housing member and the second housing member are secured to each other by a plurality of nuts and bolts.

In accordance with additional or alternative embodiments, the apparatus may further comprise a pump configured to pump a fluid towards the inlet port of the apparatus.

Further in accordance with additional or alternative embodiments, the oscillating valve of the apparatus may be a ball valve, and may include a shaft extending from at least one side of the valve body, and the electric motor is connected to the shaft and configured to rotate the oscillating valve in between a first alignment in which the opening through the valve body is aligned with and parallel to the inlet port and the outlet port of the housing, and a second alignment in which the opening through the valve body is perpendicular to the inlet port and the outlet port of the housing. The electric motor can be configured to rotate the oscillating valve 90° between the first alignment and the second alignment and is configured to reverse rotation 90° from the second alignment to the first alignment. The electric motor can also be configured to rotate the oscillating valve 180° from the first alignment to the second alignment and further configured to reverse rotation of the oscillating valve 180° from the first alignment to the second alignment and further to the first alignment. The electric motor can also be configured to rotate the oscillating valve 360°.

In accordance with still further additional or alternative embodiments of the apparatus, the apparatus may comprise one or more sensors configured to monitor one or more conditions of an environment in which the apparatus is located, including one or more of flow rate, temperature, and pressure; and a control system configured to control a speed and a frequency of rotation of the oscillating valve, based at least in part on input received by the control system from the one or more sensors. The control system can be configured to control a frequency and amplitude of the pressure waves generated by the apparatus. The control system can also be configured to control a plurality of apparatuses in an environment and is configured to control the speed and the frequency of rotation of the oscillating valve of each of the plurality of apparatuses. The control system may be further configured to control fluid flow from a pump to the inlet port of the apparatus, based at least in part on input received by the control system from the one or more sensors.

In accordance with a second aspect of the present application, as system is provided. The system comprises one or more oscillation apparatus, each oscillation apparatus comprising: a housing having an inlet port, an outlet port, and a chamber disposed in between the inlet port and the outlet port; an oscillating valve including a valve body arranged inside of the chamber having an opening passing therethrough; and an electric motor configured to rotate the oscillating valve in between a first alignment in which the opening through the valve body is aligned with and open between the inlet port and the outlet port of the housing, and a second alignment in which the opening through the valve body is not open to the inlet port and the outlet port of the housing. The system also comprises a pump configured to pump a fluid towards the inlet port of the oscillation apparatus. The oscillating valve is configured to allow a maximum fluid flow level through the oscillation apparatus when in the first alignment, a minimum fluid flow level through the oscillation apparatus when in the second alignment, and intermediate fluid flow levels when in between the first alignment and the second alignment. Rotation or oscillation of the oscillating valve between the first alignment and the second alignment creates pressure waves of fluid passing through the oscillation apparatus.

In various embodiments of the system, the system may further comprise one or more sensors configured to monitor one or more conditions of an environment in which the oscillation apparatus is located, including one or more of flow rate, temperature, and pressure; and a control system configured to control a speed and a frequency of rotation of the oscillating valve, based at least in part on input received by the control system from the one or more sensors, and further configured to control fluid flow from the pump to the oscillation apparatus, based at least in part on the input received by the control system from the one or more sensors. In further embodiments, the one or more oscillation apparatus may include a plurality of oscillation apparatuses, and where the control system is configured to control each of the plurality of oscillation apparatuses and is configured to control the speed and the frequency of rotation of the oscillating valve of each of the plurality of oscillation apparatuses.

In accordance with an additional or alternative embodiment of the system, the system comprises a fluid line configured to provide fluid from the pump to the one or more oscillation apparatus, the fluid line comprising: a first branch providing fluid from the pump in a flow path around the one or more oscillation apparatus; a second branch, branching off of the first branch, and providing the fluid from the pump to the inlet port of the one or more oscillation apparatus; and a third branch providing fluid from the outlet port of the one or more oscillation apparatus into the first branch downstream of the second branch. The rotation of the oscillating valve of the one or more oscillation apparatus between the first alignment and the second alignment creates pressure waves of fluid flowing into the one or more oscillation apparatus through the first branch and flowing out of the one or more oscillation apparatus through the third branch.

In further additional or alternative embodiments of the system, the system comprises an underground hydrocarbon reservoir, and a plurality of wells, including at least one fluid injection well and at least one hydrocarbon extraction well. The pump may be configured to pump fluid through the oscillating apparatus and into the at least one fluid injection well, and the at least one fluid injection well injects the fluid into the underground hydrocarbon reservoir in a pulsed wave of increasing and decreasing pressure in order to increase recovery of the hydrocarbon in the underground hydrocarbon reservoir. The at least one hydrocarbon extraction well may also include an oscillation apparatus submerged therein, which is configured to intake recovered hydrocarbon from the reservoir into the at least one hydrocarbon extraction well in a pulsed manner and to pump the recovered hydrocarbon aboveground. Additionally or alternatively, the pump is configured to pump fluid into the at least one fluid injection well and the fluid injection well may include an oscillating apparatus submerged therein, and the at least one fluid injection well injects the fluid into the underground hydrocarbon reservoir in pulsed waves of increasing and decreasing pressure in order to increase recovery of hydrocarbon in the underground hydrocarbon reservoir. The system may include: a plurality of fluid injection wells, each including the oscillation apparatus submerged or aboveground and configured to inject the fluid into the underground hydrocarbon reservoir in pulsed waves of increasing and decreasing pressure in order to increase recovery of hydrocarbon in the underground hydrocarbon reservoir, and a plurality of hydrocarbon extraction wells, each having an oscillation apparatus submerged therein or aboveground configured to intake recovered hydrocarbon from the underground hydrocarbon reservoir into the at least one hydrocarbon extraction well in a pulsed manner and to pump the recovered hydrocarbon aboveground. The system may further comprise one or more sensors configured to monitor one or more conditions of the underground hydrocarbon reservoir in which the apparatus is located, including one or more of hydrocarbon flow rate, temperature, and pressure; and a control system configured to control a speed and a frequency of rotation of the oscillating valve of each of the oscillation apparatuses to control fluid flow through each of the oscillation apparatuses in combination to increase their collective effectiveness, based at least in part on input received by the control system from the one or more sensors.

In additional embodiments of the system of the second aspect of the present application, the system may comprise an underground hydrocarbon reservoir, and at least one hydrocarbon extraction well including the one or more oscillation apparatus submerged therein or aboveground, which is configured to intake recovered hydrocarbon from the reservoir into the at least one hydrocarbon extraction well in a pulsed manner and to pump the recovered hydrocarbon aboveground.

In various further embodiments of the system, a container having a fluid is provided, and the one or more oscillation apparatus is configured to circulate the fluid within the container. The container can be a tank, and the one or more oscillation apparatus may include a plurality of oscillation apparatuses arranged external to the tank; wherein the system may further comprise a plurality of pumps, each pump configured to pump fluid from within the tank to one of the plurality of oscillation apparatuses; and wherein each of the plurality of oscillation apparatuses is configured to reinject the fluid into the tank in a pulsed manner to create turbulence and mixing of the fluid in the tank. The one or more oscillation apparatus may also include an oscillation apparatus arranged external to the tank, where the pump is configured to pump fluid from within the tank to the one oscillation apparatus, and the oscillation apparatuses is configured to reinject the fluid into the tank in a pulsed manner to create turbulence and mixing of the fluid in the tank. The one or more oscillation apparatus may additionally or alternatively include a plurality of oscillation apparatuses arranged inside the tank and each of the plurality of oscillation apparatuses is configured to intake the fluid from the tank and output the fluid back into the tank in a pulsed manner to create turbulence and mixing of the fluid in the tank. The one or more oscillation apparatus may additionally or alternatively include an oscillation apparatus arranged inside the tank and the oscillation apparatus is configured to intake the fluid from the tank and output the fluid back into the tank in a pulsed manner to create turbulence and mixing of the fluid in the tank.

In further embodiments of the system of the second aspect of the application, the container is an oil storage tank and the fluid is oil, and each of the one or more oscillation apparatus is configured to intake the oil from the oil storage tank and output the oil back into the oil storage tank in a pulsed manner to create turbulence and mixing of the oil in the oil storage tank to reduce an accumulation of sludge inside the oil storage tank. The container may alternatively be a storage container of an aquatic oil tanker and the fluid is oil, and each of the one or more oscillation apparatus is configured to intake the oil from the oil tanker storage container and output the oil back into the oil tanker storage container in a pulsed manner to create turbulence and mixing of the oil in the oil tanker storage container to reduce an accumulation of sludge inside the oil tanker storage container. The container may alternatively be a storage container of an oil truck and the fluid is oil, and each of the one or more oscillation apparatus is configured to intake the oil from the oil truck storage container and output the oil back into the oil truck storage container in a pulsed manner to create turbulence and mixing of the oil in the oil truck storage container to reduce an accumulation of sludge inside the oil truck storage container. The container may alternatively be a storage container of an oil rail car and the fluid is oil, and each of the one or more oscillation apparatus is configured to intake the oil from the oil rail car storage container and output the oil back into the oil rail car storage container in a pulsed manner to create turbulence and mixing of the oil in the oil rail car storage container to reduce an accumulation of sludge inside the oil rail car storage container.

In connection with any of the aforementioned implementations of the system of the second aspect of the present application, the oscillating valve can be a ball valve, which may include a shaft extending from at least one side of the valve body, and the electric motor is connected to the shaft and configured to rotate the oscillating valve in between a first alignment in which the opening through the valve body is aligned with and parallel to the inlet port and the outlet port of the housing, and a second alignment in which the opening through the valve body is perpendicular to the inlet port and the outlet port of the housing. The valve body may be a ball bearing having the opening therethrough.

In accordance with a third aspect of the present application, a method is provided. The method comprises pumping a fluid from a pump to an oscillation apparatus, the oscillation apparatus comprising a housing having an inlet port, an outlet port, and a chamber disposed in between the inlet port and the outlet port; an oscillating valve comprising: a valve body arranged inside of the chamber having an opening passing therethrough; and an electric motor configured to rotate the valve body. The method also includes, while the fluid passes through the oscillation apparatus, oscillating the oscillating valve in between a first alignment in which the opening through the valve body is aligned with and parallel to the inlet port and the outlet port of the housing and a second alignment in which the opening through the valve body is perpendicular to the inlet port and the outlet port of the housing, wherein the oscillating valve is configured to allow a maximum fluid flow level through the oscillation apparatus when in the first alignment, a minimum fluid flow level through the oscillation apparatus when in the second alignment, and intermediate fluid flow levels when in between the first alignment and the second alignment; and where rotation of the oscillating valve between the first alignment and the second alignment creates pressure waves of fluid passing through the oscillation apparatus. The method further comprises outputting the pressure waves of fluid from the oscillation apparatus.

In additional embodiments of the method of the third aspect of the present application, the method comprises sensing, by one or more sensors in an environment in which the oscillation apparatus is located, one or more conditions of the environment, including one or more of flow rate, temperature, and pressure; providing a signal containing information about the one or more conditions of the environment to a control system in communication with the one or more sensors, the pump, and the electric motor; and generating a control signal by a control system and transmitting the control signal to one or more of the pump or the electric motor configured to adjust a speed and a frequency of rotation of the oscillating valve and/or to adjust fluid flow from the pump, based at least in part on the signal provided by the one or more sensors. The method may further comprise: pumping the fluid from a plurality of pumps to a plurality of oscillation apparatuses each having an electric motor oscillating the oscillating valve while fluid passes through the respective oscillation apparatus; outputting the pressure waves of fluid from the each of the plurality of oscillation apparatuses; and generating a control signal by the control system and transmitting the control signal to the electric motor of at least one of the plurality of oscillation apparatuses to the configured to adjust a speed and a frequency of rotation of the oscillating valve, or to at least one of the plurality of pumps to adjust the fluid flow from the pump, based at least in part on the signal provided by the one or more sensors.

In additional or alternative embodiments of the method of the third aspect of the present application, the oscillation apparatus is in fluid communication with a fluid injection well of an underground hydrocarbon reservoir and outputting the pressure waves of fluid from the oscillation apparatus comprises outputting the pressure waves of fluid into the fluid injection well. In further additional or alternative embodiments, the oscillation apparatus is submerged in a fluid injection well of an underground hydrocarbon reservoir and outputting the pressure waves of fluid from the oscillation apparatus may include outputting the pressure waves of fluid into an underground hydrocarbon reservoir. The still further additional or alternative embodiments of the method, the oscillation apparatus is provided in a hydrocarbon extraction well of an underground hydrocarbon reservoir and the method further may include, intaking the fluid from the pump while oscillating the oscillating valve of the oscillation apparatus.

The method may comprise mixing a fluid stored in a container by outputting the pressure waves of the fluid from the oscillation apparatus. The oscillation apparatus can be arranged external to the container and the method further may include: pumping the fluid from inside the container to the oscillation apparatus; while the fluid passes through the oscillation apparatus, oscillating the oscillating valve of the oscillation apparatus; and outputting the pressure waves of fluid from the oscillation apparatus into the container to create turbulence within the container. The oscillation apparatus may also be submerged in the container and the method further may comprise: pumping the fluid to the oscillation apparatus; while the fluid passes through the oscillation apparatus, oscillating or rotating the oscillating valve of the oscillation apparatus; and outputting the pressure waves of fluid from the oscillation apparatus into the container to create turbulence within the container. The method may further comprise: preventing settling of a particulate in the fluid and keeping the particulate in suspension by outputting the pressure waves of fluid from the oscillation apparatus into a container may include the fluid and solid particulate therein. The container may include one or more of an oil storage tank, an aquatic oil storage tanker, an oil storage truck, or an oil storage rail car, and the method further may include reducing buildup of sludge particulate in the container by outputting the fluid in pressure waves of fluid from the oscillation apparatus and keeping sludge particulate in suspension. The container may include the fluid and a gas that is to be dispersed throughout the fluid, and outputting the pressure waves of fluid from the oscillation apparatus into a container increases dispersion of the gas in the fluid throughout the container. The container may include the fluid and a chemical and/or biological particulate that is to be dispersed throughout the fluid, and outputting the pressure waves of fluid from the oscillation apparatus into a container increases the dispersion of the chemical and/or biological particulate in the fluid throughout the container.

### BRIEF DESCRIPTION OF THE DRAWINGS

FIG. 1A shows a longitudinal sound wave propagating in air and having a sinusoidal form with pressure peaks and troughs shown in relation to atmospheric pressure;

FIG. 1B shows the wave of FIG. 1A causing air particle displacement parallel to the direction of propagation;

FIG. 1C shows destructive interference caused when waves meet out-of-phase;

FIG. 1D shows constructive interference caused when waves meet in-phase;

FIG. 2A shows an exploded view of an oscillator according to the present application;

FIGS. 2B-2C show perspective views of an oscillator according to the present application;

FIG. 2D shows an example of rotating the ball of the oscillator according to the present application;

FIG. 3A-3D shows different shaped flow paths in the ball of the oscillator according to the present application;

FIG. 4 shows an oscillator system according to the present application;

FIGS. 5A and 5B show examples of an oscillating valve arrangement in a fluid flow, in a minimum flow state (FIG. 5A) and a maximum flow state (FIG. 5B), in accordance with an embodiment of the present application;

FIGS. 6A and 6B show examples of an oscillator arrangement in a fluid flow, in a minimum flow state (FIG. 6A) and a maximum flow state (FIG. 6B state, in accordance with an embodiment of the present application;

FIG. 7 shows flow simulation at variable rotation speeds;

FIG. 8A illustrates an in-line oscillator installation in accordance with an embodiment of the present application;

FIG. 8B shows a parallel path oscillator installation, in accordance with an embodiment of the present application;

FIG. 9A shows an example an oscillator system of the present application used in an injection well and a production well;

FIG. 9B shows an example of a submersible application of the oscillator system of the present application used in an injection well and a production well;

FIG. 10A shows an example of an external pump and a submersible application of the oscillator system of the present application used in a production well;

FIG. 10B shows a vertical injection and production wells incorporating the oscillator for the creation of pulsing pressure waves for volumetric extraction;

FIG. 10C shows an analysis for use of the oscillator in a production well;

FIGS. 10D and 10E show a comparison between viscous fingering in a non-pulsing system (FIG. 10D) and viscous fingering in a pulsing system (FIG. 10E);

FIGS. 11A and 11B show energy systems using pulsed liquid to heat an oil reservoir;

FIG. 12 shows a heat and fluid flow matrix in horizontal wells;

FIGS. 13A and 13B show horizontal and vertical well flow comparisons;

FIGS. 14A-14C show heat and oil delivery matrices over time;

FIG. 15 illustrates flow modes for mixing or blending of a fluid;

FIGS. 16A and 16B show an application for mixing fluid in a tank with exterior oscillators according to the present application;

FIG. 17 shows a mode mixing application for mixing fluids in tanks with exterior oscillators according to the present application;

FIG. 18 shows an application of the oscillator system in mixing fluids in small tanks using exterior oscillators according to the present application;

FIG. 19 shows an application of the oscillator system in mixing fluids in small tanks using submersible oscillators according to the present application;

FIGS. 20A-20D show applications to eliminate sludge with pressurized waves generated by the oscillator system according to the present application; and

FIG. 21 shows use of an oscillator system according to the present application in optimizing of fluid flow by minimizing drag.

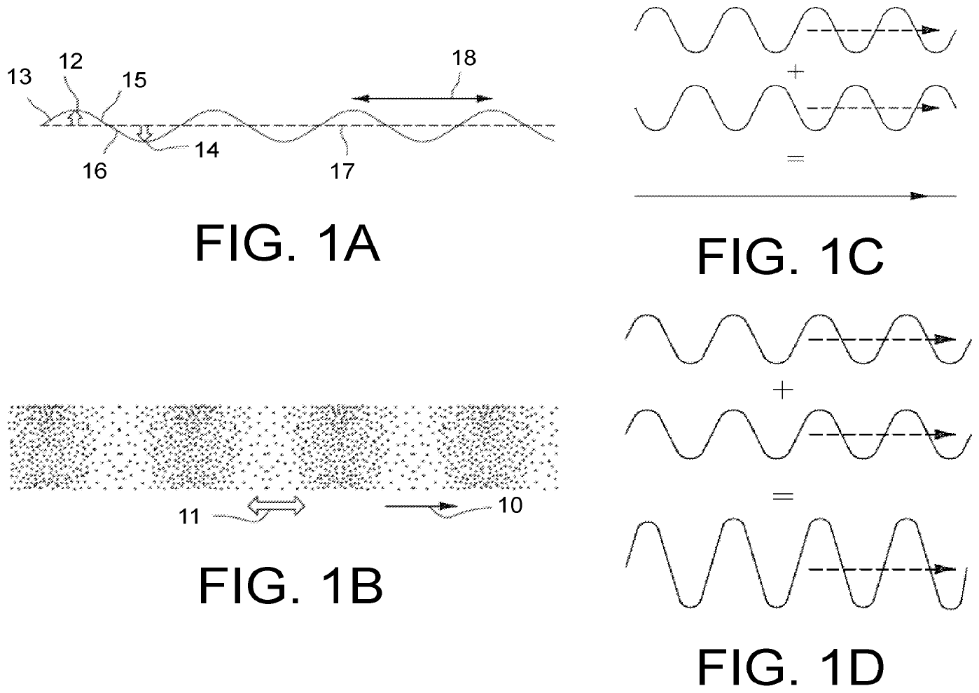

### DETAILED DESCRIPTION OF THE DRAWINGS

In accordance with the present application, an oscillator system is provided for generating waves wherein using constructive and destructive interference, waves generated by the oscillator system can be used for many applications, such as: optimizing flow patterns, mixing fluids by creating mixing modes, improving fluid velocity, reducing pumping costs, reducing the impact of corrosion, noise, and vibration cancellation, breaks down flow restrictors, and herding fluids in a volumetric space.

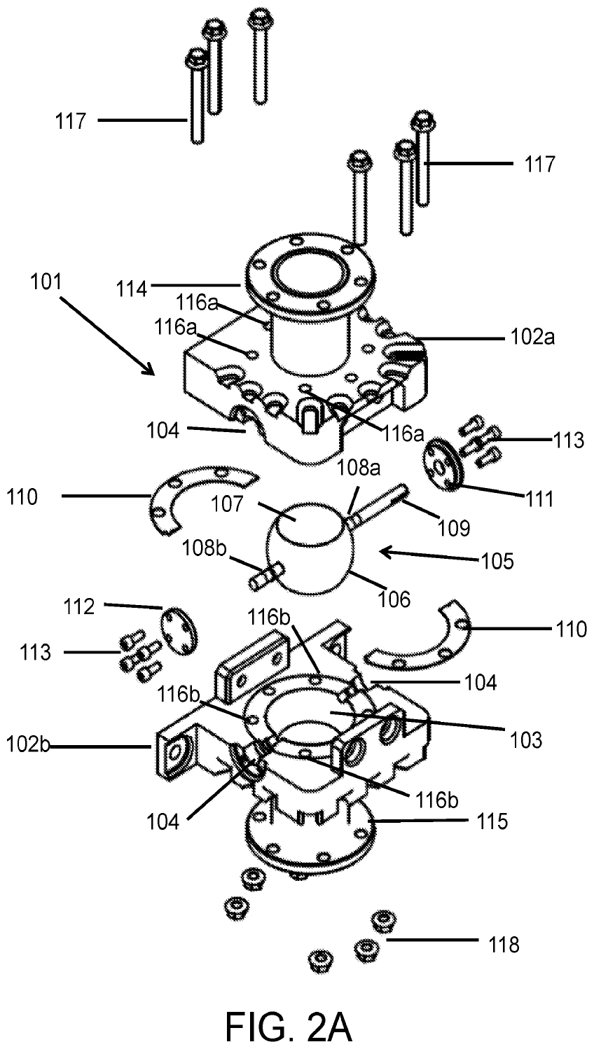

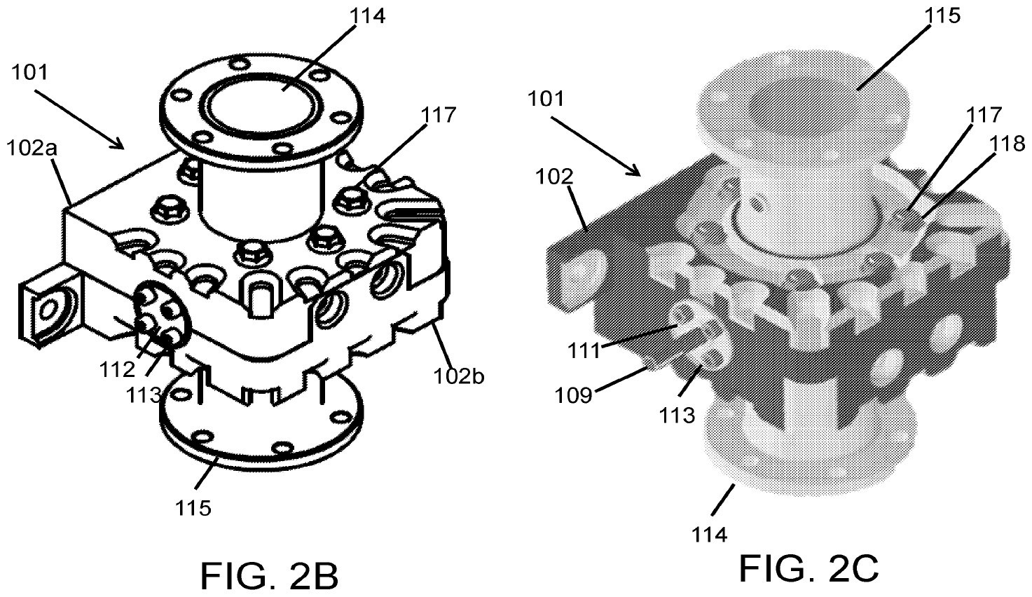

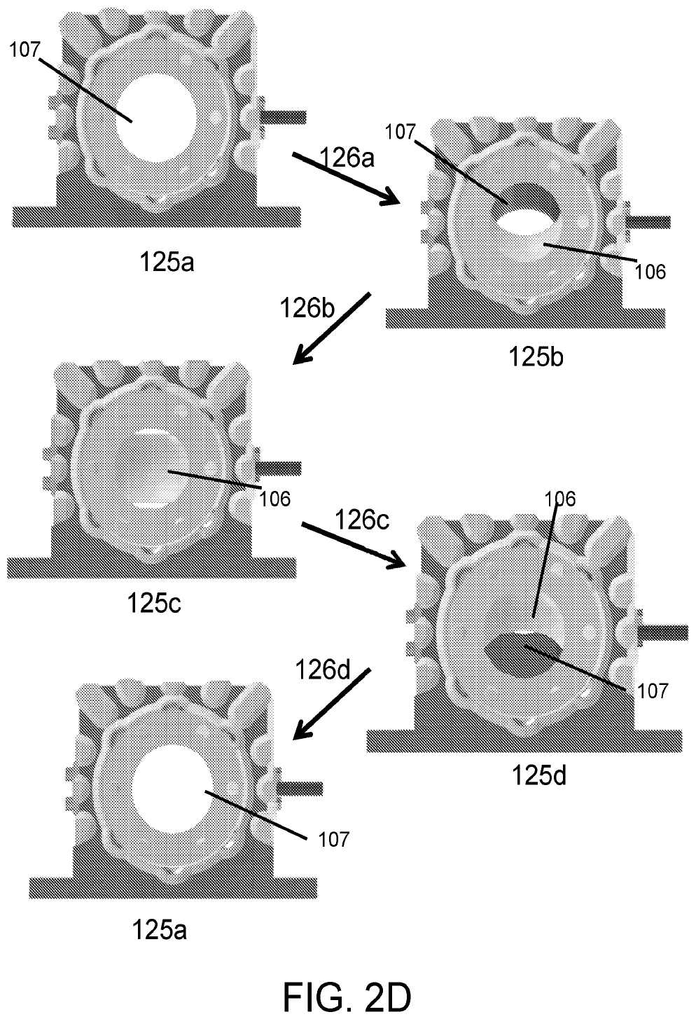

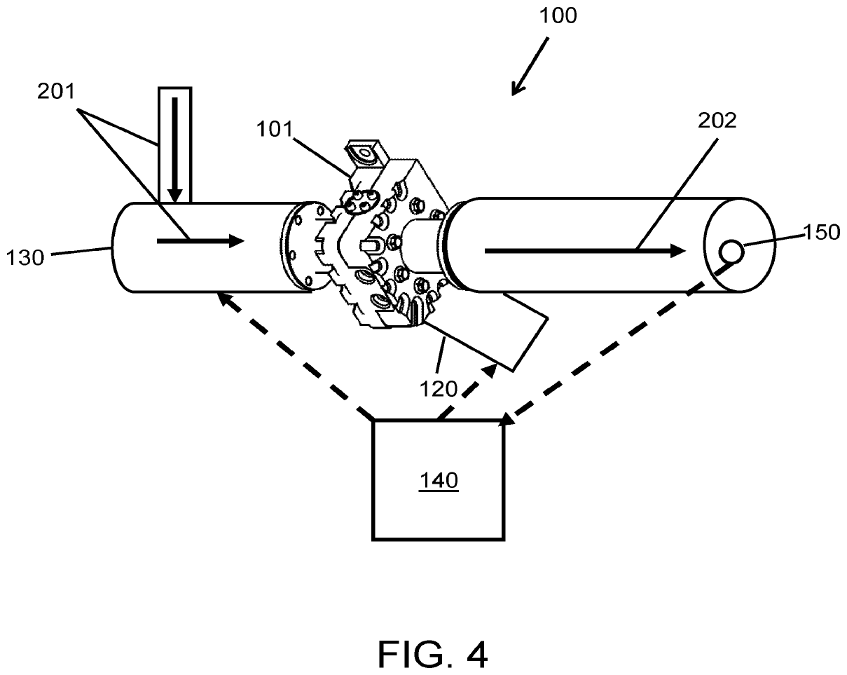

An oscillator 101 according to the present application is shown in FIGS. 2A-2C, with exemplary oscillating valves 105, 105a for use in the oscillator system 100 shown in FIG. 4. In accordance with the present application, oscillating valves 105 are used to open and close flow paths (e.g., pipes) for fluid flow. By using one or more oscillating valves 105, oscillations are created by oscillating the oscillating valve 105 at an RPM (revolutions per minute) that creates the frequency of the wave. The magnitude of the wave is created by the pressure of the fluid.

In the embodiment of the oscillator 101 illustrated in FIGS. 2A-2C, the oscillator 101 comprises a housing 102. The housing 102 comprises an upper housing 102a secured to a lower housing member 102b. Within the housing 102, a chamber 103 is formed, which is configured to house a valve body 106 of an oscillating valve 105. Channel portions 104 may also be provided on adjacent surfaces of the upper housing 102a and lower housing 102b and on opposing sides of the chamber 103, which are configured to receive a shaft 108 on each side of the valve body 106. In the oscillator 101 shown in the Figures, the upper and lower housing 102a, 102b are secured to each other using a series of bolts 117 and nuts 118. The upper housing 102a comprises a series of openings 116a and the lower housing 102b comprises a corresponding series of openings 116b, which are configured to align with the openings 116a through the upper housing 102a, and the bolts 117 pass through the openings 116a, 116b to secure the upper and lower housing 102a, 102b to each other, with the utilization of nuts 118. In other embodiments, the upper and lower housing 102a, 102b can be affixed to each other using other mechanisms, such as clamps, threading, snap fits, and other suitable connecting means known in the art.

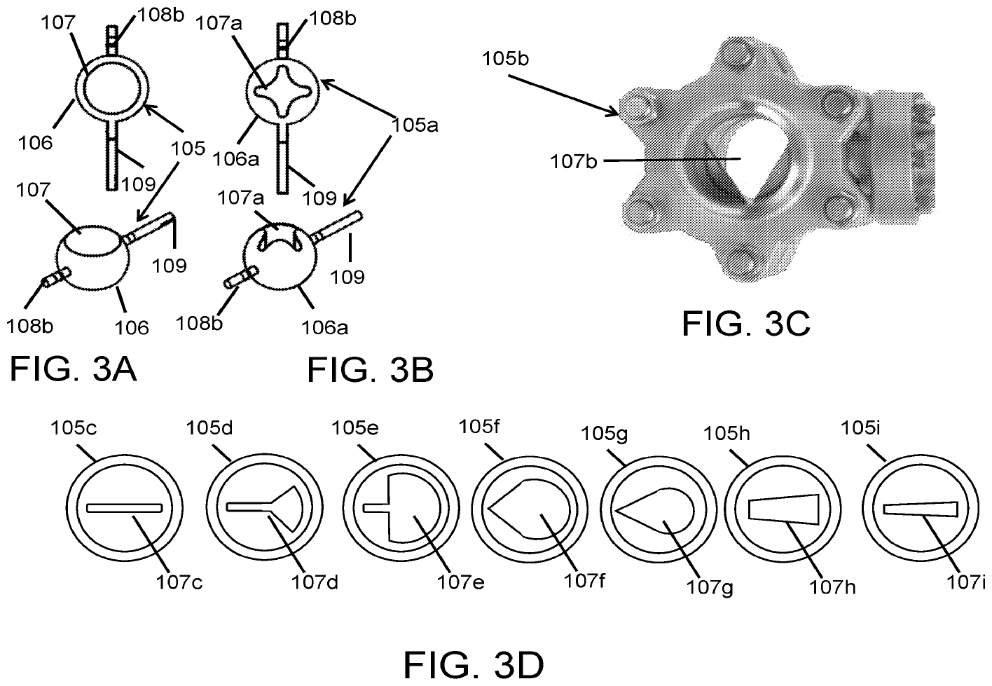

In accordance with embodiments of the present application, the oscillating valve 105 comprises a valve body 106 having an opening 107 formed therethrough. In the embodiments illustrated in the Figures and described herein, the oscillating valve 105 is a ball valve comprising a ball bearing as the oscillating valve body 106 having the opening 107 formed therethrough. The dimensions and shape of the opening 107 through the valve body 106 of the oscillating valve 105 can vary. As shown for example in FIG. 3A, a substantially circular opening 107 can be provided through the valve body 106. The circular opening 107 may be dimensioned with the same or similar cross-sectional area as the upper and lower housing ports 114, 115 so as to substantially align with the upper and lower housing ports 114, 115 every 180° rotation of the oscillating valve 105. However, as shown for example in FIG. 3B, alternative oscillating valves 105a can be provided having an opening 107a that is not circular, but may take a different cross-sectional shape such as a four-pointed star. The oscillating valve opening 106 is not limited to any particular cross-sectional shape, and FIGS. 3C and 3D illustrate additional oscillating valves 105b, 105c, 105d, 105e, 105f, 105g, 105h, 105i each having a differently shaped opening 107b, 107c. 107d, 107e, 107f, 107g, 107h, 107i. The different flow that occurs through different shapes of the openings of the valves can determines the shape of the wave.

The oscillating valve 105 also comprises a shaft 108a extending from an outer surface of the valve body 106 and secured to the valve body 106. Two shafts 108a, 108b may be provided on two opposing sides of the valve body 106 as shown in FIG. 2A, or only a single shaft 108a may be provided on only one side in other embodiments. The shaft 108a comprises on an end furthest from the valve body 106 a shaft connector 109, which is configured to connect the shaft 108 and oscillating valve 105 to an electric motor 120. The electric motor 120 causes the shaft 108a to rotate, thereby causing the entire oscillating valve 105 to rotate. In embodiments where the oscillating valve 105 is not a ball valve, the electric motor 120 may control the opening and closing of the oscillating valve 105 in alternative manners.

A cap 111, 112 can be provided over each of the shafts 108a, 108b for covering the shafts 108a, 108b. The caps 111, 112 can be secured to the housing 102 by way of screws 113, which for example may be threaded screws 113 configured to engage threaded openings on the upper and lower housing 102a. 102b. Corresponding cutouts may also be provided on the upper and lower housing 102a, 102b that are shaped and dimensioned to receive each of the caps 111, 112 therein. The cap 111 that is adjacent to the shaft connector 109 may comprise an opening through the cap 111 through which the shaft connector 109 may pass to connect to the motor 120.

The upper housing 102a of the oscillator 101 comprises a port 114 and the lower housing 102b of the oscillator 101 also comprises a port 115. The two ports 114, 115 align with each other, and have the chamber 103 and oscillating valve 105 arranged between them. The ports 114, 115 may also comprise elements that allow the ports 114, 115, and by extension the oscillator 101, to be connected to other objects used with the oscillator system 100, such as a pump 130 or pipes 160. For example, in the embodiments shown in the Figures, the ports 114, 115 each comprise a circumferential flange having a plurality of through holes that may be configured to receive a bolt or screw to connect the flange to a pump or pipe having corresponding through holes. Other connection means can be used to connect the oscillator 101 to pumps, pipes, hoses, or other fluid communication lines, such as clamps, threading or other suitable connecting mechanisms known in the art.

FIG. 2D shows an example oscillation of the oscillating valve 105 within the oscillator 101. In a first position 125a, the oscillating valve opening 107 is in alignment with the ports 114, 115. As the electric motor 120 causes the oscillating valve 105 to rotate 126a, the oscillating valve opening 107 progressively moves out of alignment with the ports 114, 115 and has an intermediate, partially open position 125b. The oscillating valve continues to rotate 126b to a “closed” position 125c. As such, the flow through the ports 114, 115 progressively decreases from its maximum flow position 125a (i.e., when the oscillating valve opening 107 aligns with and is parallel the ports 114, 115) to a position 125c with minimum or no flow (i.e., when the oscillating valve opening 107 has rotated 90° in either direction and to be perpendicular to the ports 114, 115). Then oscillating valve 105 continues rotating 126c from the “closed” position through a further intermediate positions 125d, and further rotates 126d back to an open position 125a, where the rotation cycle repeats. Thus, the flow through the oscillating valve 105 progressively increases back to its maximum flow position 125a (i.e., when the oscillating valve opening 107 has rotated a further 90° in either direction and realigns with and is parallel the ports 114, 115). The oscillating valve 105 is configured to oscillate or rotate between these two positions 125a, 125c to open and close the oscillating valve 105, while allowing moderated flow to pass through the oscillating valve opening 107 in positions 125c, 125d between the maximum and minimum flow positions. The rotation of the oscillating valve 105 can be 360°, as shown in the example of FIG. 2D, or can be less than a full rotation but an alternating and reversing rotation of between 0° and 90°, between 90° and 180°, or between 0° and 180°, such as a rotation of 45°, 90°, 135°, or 180°. For example, the oscillating valve 105 may rotate 90° from an open position allowing a maximum flow to a “closed” position where a minimum flow is allowed, and may then rotate back 90° in the opposite direction from the fully closed position to the open position, or may rotate 90° further in the same initial direction (a 180° rotation) from the closed position to the open position before reversing 180°. The oscillating valve 105 does not fully close, even in the minimum flow state or “closed” position, as leakage of fluid is allowed through the valve in this state to prevent hammering. A gasket 110 can be provided in between the upper and lower housing 102a, 102b and around the valve body 106 of the oscillating valve 105.

An oscillator system 100 according to the present application is found in FIG. 4. The oscillator system 100 may be used with or comprise a control system 140, which based on sensor 150 feedback, and controls the frequency and amplitude of pressure waves. The control system 140 receives a sensor input on a parameter such as pressure (e.g., sound pressure) from pressure sensors 150 and controls the oscillator system 100. The control system 140 measures the resultant pressure waves with the one or more sensors 150. By managing the pressure waves, the control system 140 can, for example, create constructive re-enforcement of the pressure waves in a reservoir to maximize their effectiveness in enhancing oil and gas flow and recovery. Once a starting frequency is selected, the frequency can be increased and/or decreased by the control system 140 until the maximum objective of the application of the oscillator system 100 is achieved. More than one frequency can be used over the course of generating the pressure waves. Because the pressure waves may travel through different media at different speeds, in such applications, the control system 140 can be configured to adjust the timing of the pressure waves to ensure the maximum effect on the oil and gas extraction (or other application). The control system 140 can be used in combination with multiple oscillators 101

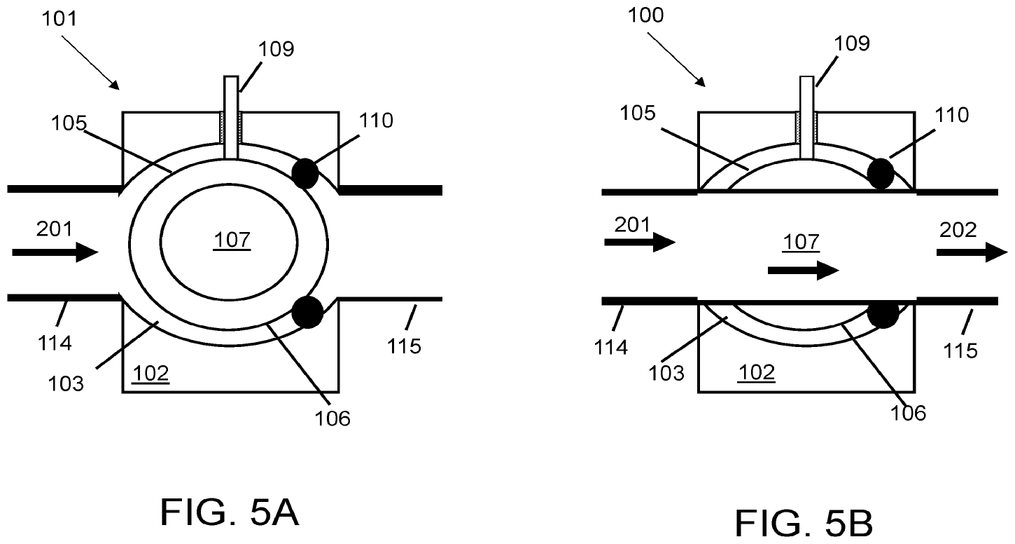

The oscillator system 100 may comprise a pump 130 as part of the oscillator system 100 or separately. The pump 130 provides a fluid flow 20 to one of the ports of the oscillator 101. In the arrangement shown in FIG. 4, the pump 130 is connected to the lower housing port 115 of the oscillator 101, but this arrangement may be reversed, or the pump 130 can be indirectly connected to the oscillator 101, such as by a fluid line or pipe in between the pump 130 and the oscillator 101 that is configured to supply a fluid 201 to the oscillator 101. The fluid 201 passes through the oscillator 101 and the oscillator 101 provides a fluid output 202 through a pipe 160 or directly out of the oscillator 101 into a fluid reservoir or tank. If the electric motor 120 of the oscillator 101 is off, the oscillating valve 105 inside the oscillator 101 has the opening 107 in alignment with the ports and the fluid 201 may pass through the oscillating valve 105 of the oscillator 101 as a steady fluid flow 202. When the electric motor 120 is powered on, the electric motor 120 causes the oscillating valve 105 to rotate, which oscillates the fluid flow into and out of the oscillator 101. FIG. 5A and FIG. 5B show an oscillator 101 with a closed oscillating valve 105 (FIG. 5A) and an opened oscillating valve 105 (FIG. 5B).

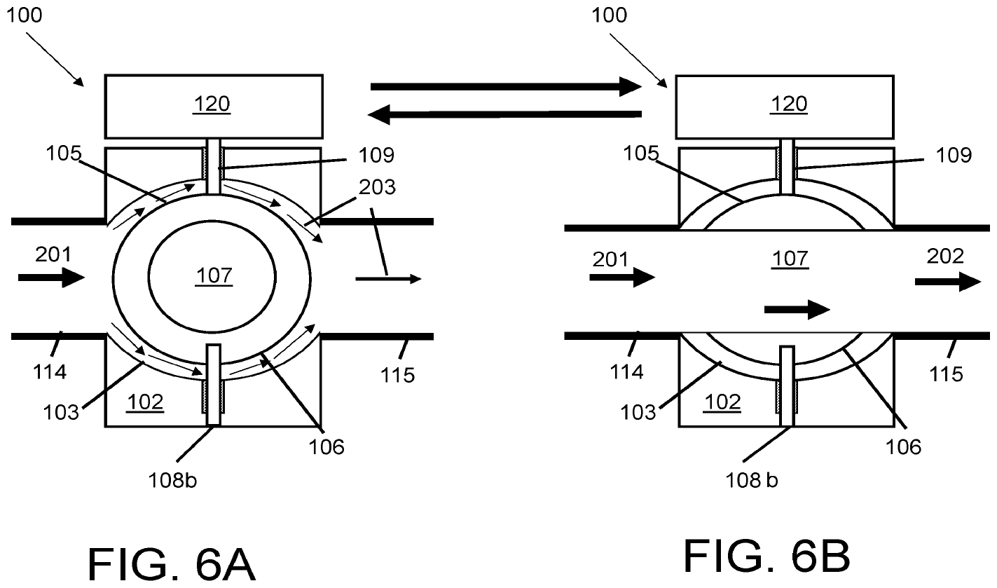

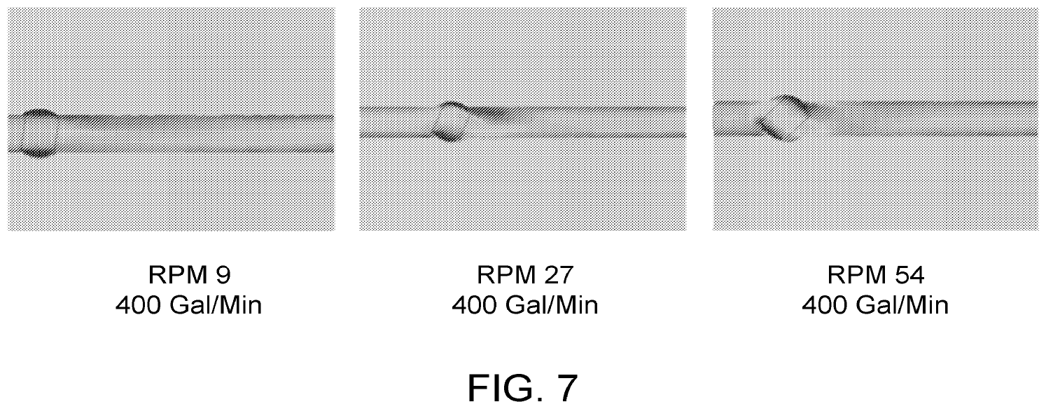

FIGS. 6A-6B show the oscillation of the oscillator 101 oscillating valve 105 between a closed (FIG. 6A) and open position (FIG. 6B). As shown for example in FIG. 6A (as well as FIG. 2D), there will be some fluid 203 that leaks through the oscillating valve 105 even when in the “closed” position where the flow is minimized. This leakage 203, which is present but not shown in FIG. 5A, prevents the oscillator 101 from hammering during use. This may result from the shape of the oscillating valve 105, as shown for example in the closed position 125c of FIG. 2D, where the oscillating valve 105 includes exposed passages when it is rotated to a position where the oscillating valve opening 107 is perpendicular to the ports 114, 115. As indicated by the two arrows in between the electric motors in FIGS. 6A and 6B, the electric motor 120 rotates the connector shaft 109 of the oscillating valve 105 to rotate to open and close the oscillating valve 105.

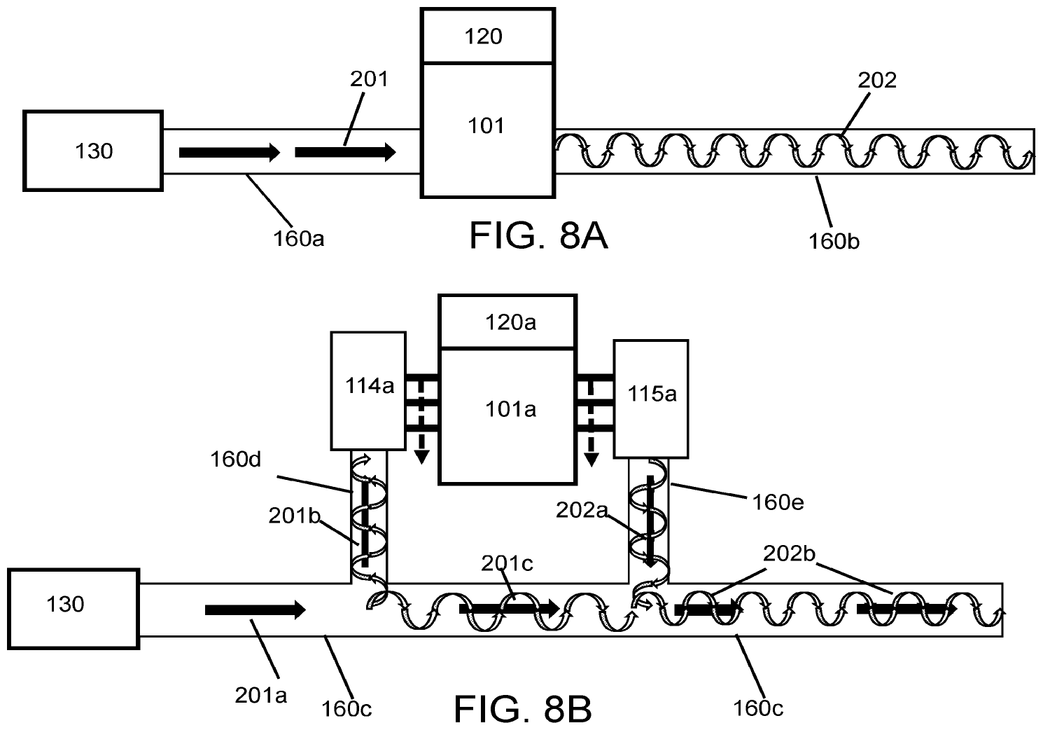

FIG. 8A shows a simplified operation of the oscillator system 100. A pump 130 is connected to the oscillator 101 by way of a pipe 160a connected to the pump 130 and a port 114/115 of the oscillator 101. The pump 130 provides fluid 201 from a fluid source (not shown) to the oscillator 101, and the electric motor 120 rotates the oscillating valve 105 of the oscillator 101 in order to provide a pulsed fluid 202 through a second pipe 160b connected to the other port 114/115 of the oscillator.

FIG. 8B shows an alternative arrangement having parallel fluid lines and incorporating the oscillator 101 to provide a pulsed fluid. As in FIG. 8A, a pump 130 provides fluid 201a from a fluid source (not shown) through a pipe 160c. The pipe 160c includes a first branch 160d off of the pipe 160c (which can be a separate pipe or fluid line or an integral pipe or fluid line), which supplies the fluid 201b to an oscillator input 114a. The oscillator input 114a may include a plurality of ports, each in communication with an oscillator 101a comprising a motor 120a. Although only one oscillator 101a and motor 120a is shown in the Figure, it is to be understood that a plurality of oscillators 101a and motors 120a are provided. The plurality of oscillators 101a each output the fluid to an oscillator output 115a, which supplies the fluid 202a through a pipe branch 160e that rejoins the pipe 160c. The pipe branch 160e can be a separate pipe or fluid line from the pipe 160c or an integral pipe or fluid line with the pipe 160e.

The oscillators 101a with electric motors 120a are configured to rotate the oscillating valves 105 therein, as previously described herein and output a pulsed fluid 202a. Further, FIG. 8B also demonstrates that the opening and closing of the oscillating valve 105 of the oscillators 101a also causes the fluid 201b entering the oscillator 114a to be pulsed. As the pump 130 provides a steady supply of the fluid 201a, as the oscillating valves open and close, the fluid 201a builds up on the input side and experiences increases and decreases in fluid pressure as the oscillators 101a open and close. This results in a pulsed fluid 201b being provided to the oscillator input 114a. Additionally, as the pipe 160c continues in parallel to the oscillators 101a and in between the two pipe branches 160d, 160e, a pulsed fluid 201c is created in the pipe 160c even prior to the fluid output 202a from the oscillators 101a being fed back into the pipe 160c. The pulsed fluid 201c generated in parallel to the oscillators 101a flow path is mixed with the pulsed fluid 202a that is provided by the pipe branch 160e to provide a mixed and pulsed fluid 202b. The control system 140 (not shown in FIG. 8B) of the oscillator system 100 may be configured to control the opening and closing of the oscillating valves 105 of the oscillators 101a and the operation of the pump 130 to ensure that the two sources of pulsed fluid 201c, 202a interfere constructively, as described herein, so that the pulsed fluid 202b can provide the maximum impact for the intended application of the oscillator system 100.

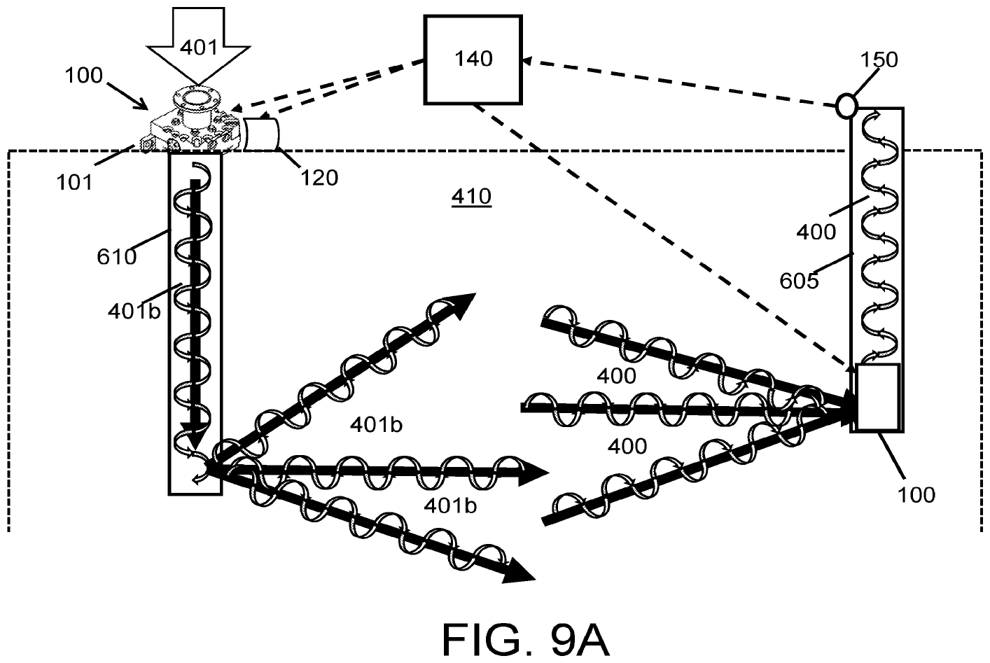

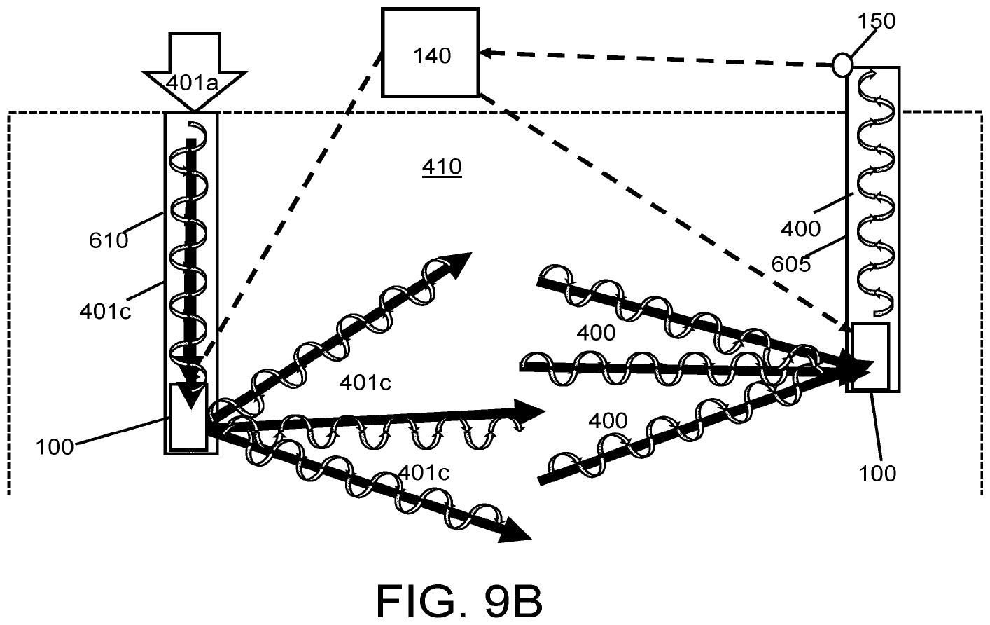

The oscillator system 100 according to the present application can be utilized in applications for oil, gas or other hydrocarbon extraction. FIG. 9A shows an example of an application of the oscillator system 100 used in an injection well 610 and a production well 605 in an underground hydrocarbon reservoir 410. Fluids and/or other chemicals 401 are supplied to an oscillator 101 of the oscillator system 100. The oscillator 101 pulses the fluid 401b through an injection well 610 into the underground reservoir 410, where it is dispersed to stimulate the recovery of oil (or gas) 400 from the reservoir 410. A producer well 605 is also provided, which collects or extracts the oil (or gas) 400 to provide to the surface for collection. The producer well 605 may also include an oscillator system 100 at the base where the oil or gas 400 is collected, including an oscillator 101 and pump 130.

FIG. 9B shows an example of submersible oscillator systems 100 used in an injection well 610 and a production well 605 in an underground reservoir 410. Fluids and/or other chemicals 401a are supplied to an injection well 610 into the underground reservoir 410. The injection well 610 comprises an oscillator system at the base or near the location in the well through which the fluid is dispersed, and the oscillator 101 pulses the fluid 401c, where it stimulates the recovery of oil (or gas) 400 from the reservoir 410. A producer well 605 is also provided, which collects or extracts the oil (or gas) 400 to provide to the surface for collection. The producer well 605 may also include an oscillator system 100 at the base where the oil or gas 400 is collected, including an oscillator 101 and pump 130.

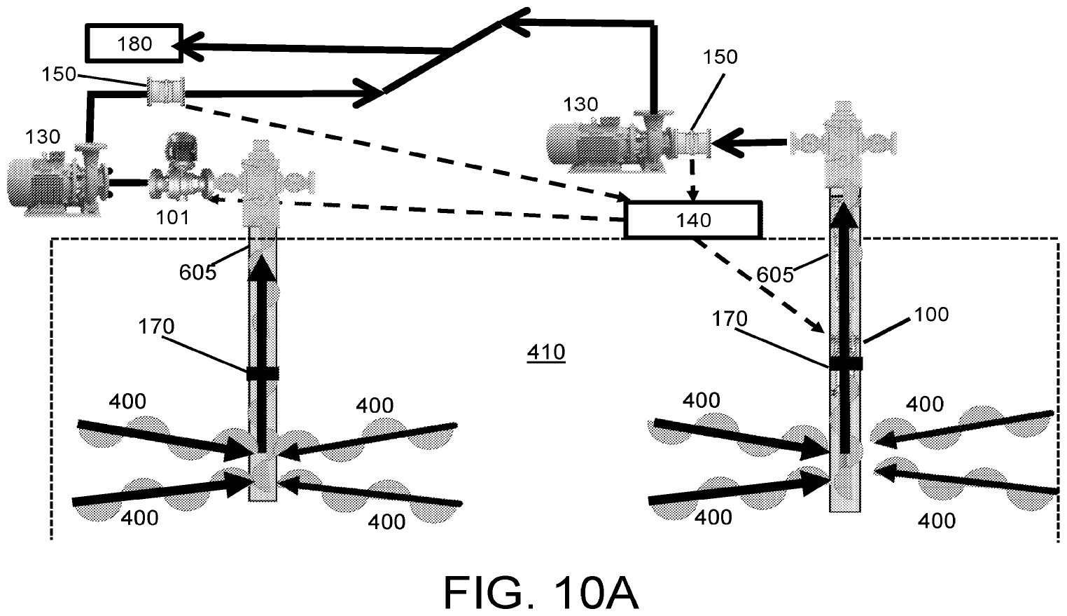

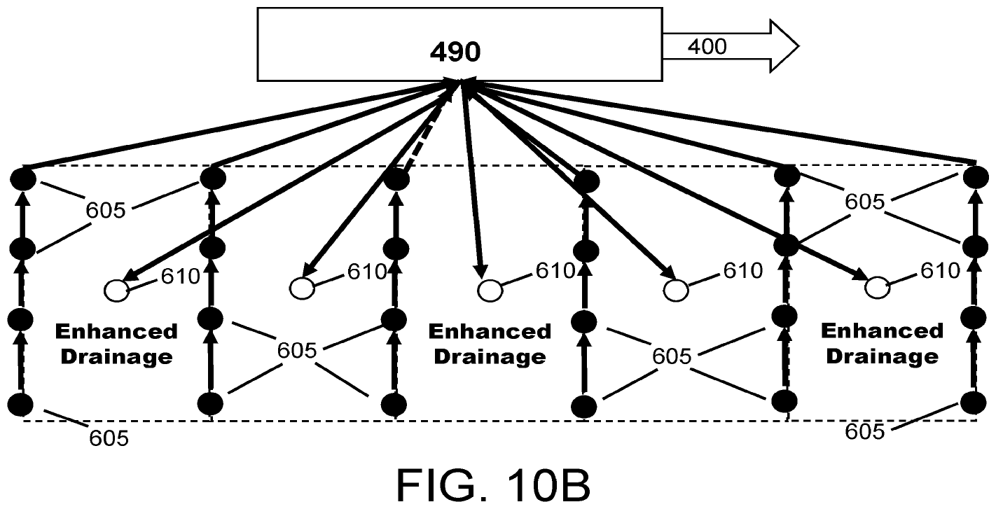

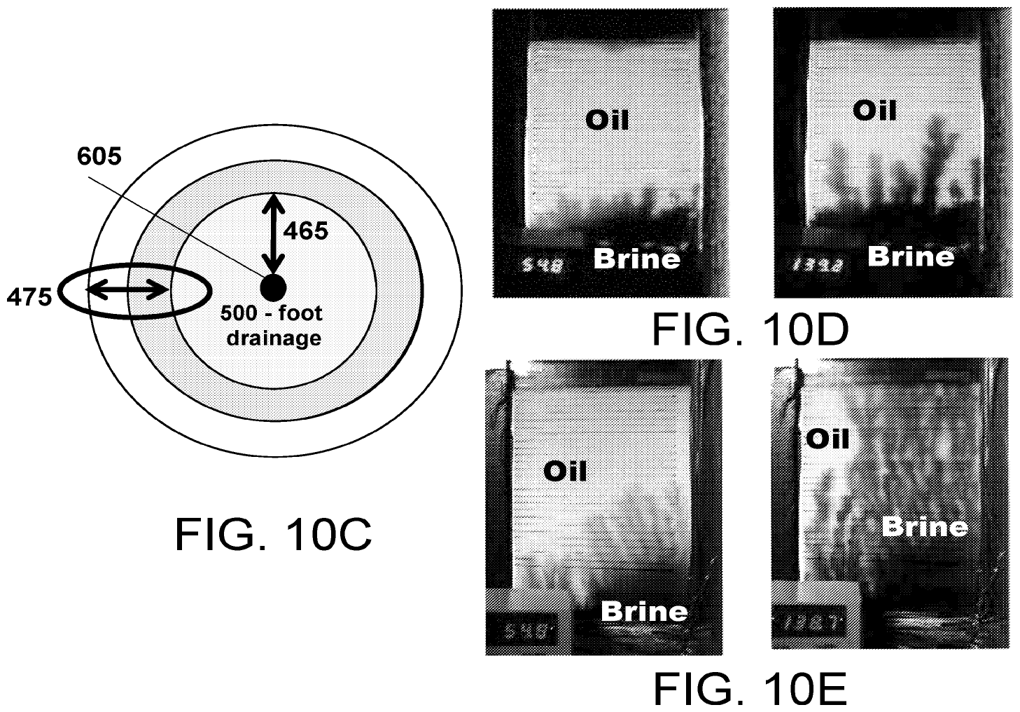

FIG. 10A shows an example of an application of the oscillator system 100 used solely in with production wells 605 for an underground hydrocarbon reservoir 410. Fluids and/or other chemicals may optionally be provided to an injection well (not shown). The producer well 605 collects the oil (or gas) to provide to the surface for collection and providing to a tank farm 180 or other oil or gas repository. As shown on the right side of FIG. 10A, the producer well 605 may include an oscillator system 100 at the base where the oil or gas 400 is collected, including an oscillator 101, electric motor (not shown), and a packer 170 inside the production well 605, and having a pump 130 with flow sensors 150 aboveground. The use of the oscillator system 100 in the producer well 605 causes the oil 400 (or gas or other hydrocarbon) in the reservoir to be pulled into the well 605 in a pulsed manner by opening and closing the oscillating valve 105, creating pressure changes that increase the recovery of the oil 400. The pump 130 operates as a vacuum pulling the oil 400, while the oscillator 101 pulses these pulls to increase the reach of the pull to improve the extraction and flow of the oil into the production well 605. As shown on the left side of FIG. 10A, additionally or alternatively, the production well 605 may be provided with the oscillator 101 located above ground.

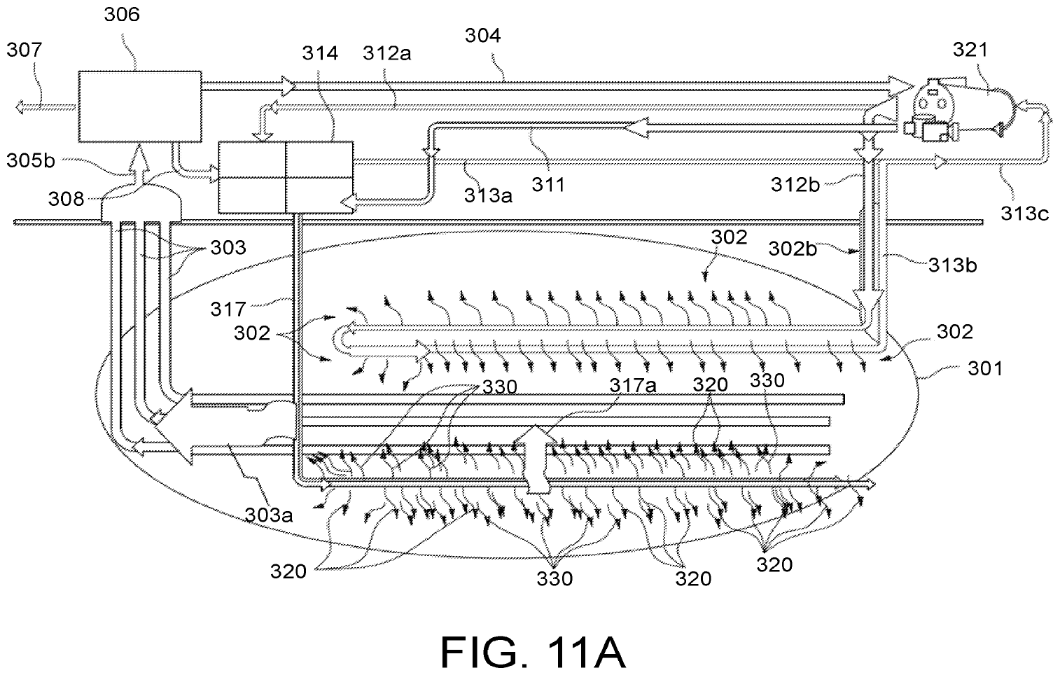

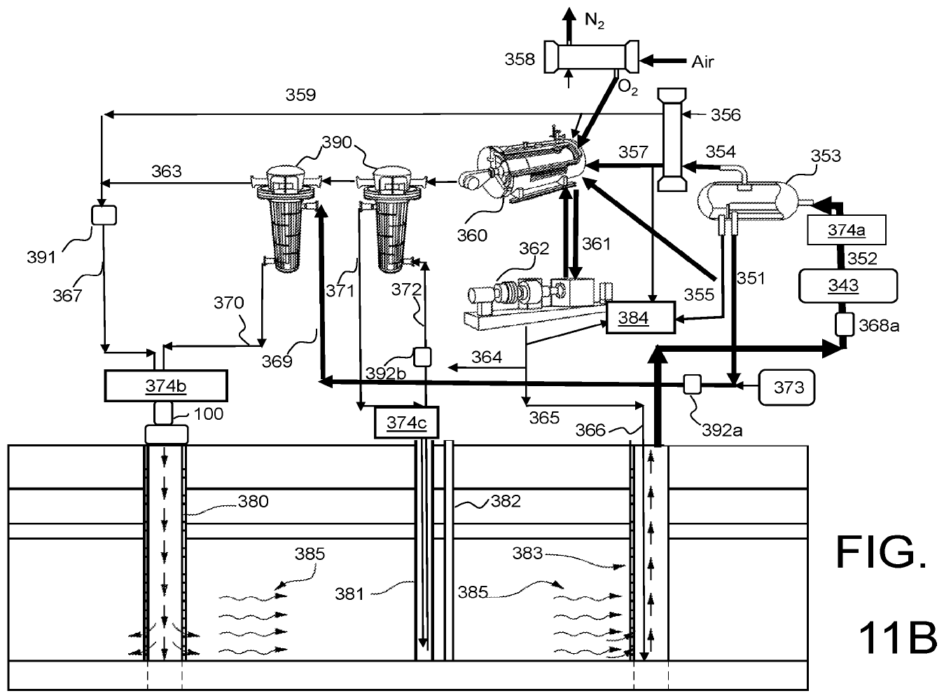

FIG. 10B shows a top view of a reservoir incorporating five vertical injection wells 610 and twenty-four vertical production wells 605 in an underground hydrocarbon reservoir 410. The production wells 605 are provided with oscillation systems (not shown) as described for example above with respect to FIG. 10A, which enhance the drainage area and sweep within the reservoir, allowing a greater volume of oil to be extracted. The injection wells 610 and production wells 605 can be used with a comprehensive oil or energy system 490, as are discussed below in greater detail with respect to FIGS. 11A-14C, and the recovered oil 400 provided from the producer wells 605.

FIG. 10C shows the change in drainage that can be provided by the oscillation system 100 used with a production well 605. Whereas atypical drainage 465 without the use of a pulsing oscillator 100 may be five hundred feet, an increased drainage 475 is provided. Table 1 illustrates the changes in drainage that can be provided by the oscillator and the resulting sweep volume.

TABLE 1
Comparison of Flows Between Horizontal and Vertical Production Wells

| | | Sweep (Cubic feet) | Additional | | Additional |
|---|---|---|---|---|---|
| Pay zone | Drainage | [Pay Zone · | drainage | New | Cubic Feet |
| (feet) | (feet) | Drainage² · π] | feet | Cubic Feet | of Oil |
| 50 | 500 | 39,250,000 | 100 | 56,520,000 | 17,270,000 |
| 50 | 500 | 39,250,000 | 150 | 66,332,500 | 27,082,500 |
| 50 | 500 | 39,250,000 | 200 | 76,930,000 | 37,680,000 |
| 50 | 500 | 39,250,000 | 250 | 88,312,500 | 49,062,500 |
| 50 | 500 | 39,250,000 | 300 | 100,480,000 | 61,230,000 |
| 50 | 500 | 39,250,000 | 350 | 113,432,500 | 74,182,500 |

By applying the oscillation system 100, the effective extraction is increased. Depending on the reservoir by providing the right pump pressure the drainage can be increased by as much as 85%. The use of pulsing with a production well is estimated to provide a benefit of 30%

FIG. 10D shows examples of viscous fingering in a connate paraffin oil example where pulsing was not used after approximately 55 seconds (left) and approximately 139 seconds (right). In comparison, FIG. 10E shows examples of viscous fingering in a connate paraffin oil example where pulsing was used after approximately 55 seconds (left) and approximately 139 seconds (right). Exemplary results of the pulsing based on tests that include pulsing and non-pulsing for oil recovery include: a faster general flow rate with pulsing, slower water breakthrough with pulsing, oil cuts that remain higher for longer with pulsing, a far greater oil sweep efficiency with pulsing, a suppressed viscous finger length with pulsing, and a greater stability of a fingering front with pulsing.

The oscillator system 100 according to the present application may also be utilized in comprehensive energy systems, such as those described in U.S. Provisional Patent Application 63/249,439 filed Sep. 28, 2021, or U.S. Pat. No. 10,267,128 (issued Apr. 23, 2019) and U.S. Pat. No. 10,443,364 (issued Oct. 15, 2019) both filed Apr. 7, 2017 and U.S. patent application Ser. Nos. 15/517,616 and 15/517,572 filed Apr. 7, 2017, which are all hereby incorporated by reference in their entirety. Examples of such energy systems are shown in FIGS. 11A and 11B.

FIG. 11A shows an embodiment where the fluid heated in a boiler 321 is circulated in a closed loop above ground to and from a heat exchanger/mixer 314, and also below ground in a heat delivery well 302b in an underground oil/gas/brine reservoir 301. The heat delivery well 302b may be fed circulating hot fluid 312b by the boiler 321, by a separate boiler, or by another type of heat source. Wavy arrows 302 are shown emanating from the heat delivery well 302b in the reservoir 301 to signify the transfer of heat to the oil/gas/brine reservoir 301. Oil, gas, and brine produced from one or more production wells 303 is provided on a line 305b to at least separator 306 that provides separated gas on a line 304 to the boiler 321, separated oil on a line 307 for storage, and separated brine on a line 308 to the heat exchanger/mixer 314. The separated gas is not flared, but used to increase hydrocarbon recovery flow rate. Hot exhaust 311 from the boiler 321, or from the turbine or generator, is provided to a mixer part of the heat exchanger/mixer 314 for mixing with the separated brine 308. The hot brine/exhaust mixture is injected into an injection well 317, where hot brine flooding takes place to heat the reservoir, displace the trapped hydrocarbons, and push or move the hydrocarbons toward the one or more production wells 303. Wavy arrows 320, 330 are shown emanating from the injection well 317 into the reservoir 301 to signify the delivery of hot brine/CO₂ to heat the oil/gas/brine reservoir 301 and to push and displace gas and oil toward the one or more production wells 303. Hot water 312a from the boiler 321 is provided to the heat exchanger/mixer 314 where it transfers heat to the separated brine 308. The cooled fluid emerging from the heat exchanger on a line 313a may be joined with cooled fluid 313b emerging from the heat delivery well 302b before the joined fluids 313c are together returned to the boiler 321 for re-heating. The re-heated fluid 312a emerges from the boiler 321 for providing to the heat exchanger/mixer 314, and hot fluid 312b circulated to the heat delivery well 302b in a repeating cycle of heating, cooling, and re-heating.

Also shown in FIG. 11A, pressure waves 303a may be generated in both the one or more production wells 303 and additional pressure waves 317a in the at least one injection well 317. The underground placement of the production and injection wells with respect to each other may be advantageously set up such that constructive interference is facilitated and controlled with the production and injection waves controlled so as to be stimulating the reservoir simultaneously, continuously and synchronized in phase so as to meet in the reservoir and add constructively, thereby increasing the amplitude of the stimulating force imparted to the reservoir. The spatial relationship should be such that at least part of the pressure wave 303a is propagated in a direction toward the injection well 317 and the injection pressure wave 317a is propagated in the opposite direction toward the production well 303 so that the waves meet in a space in between the wells and interfere constructively. These pressure waves can be created using an oscillator system 100.

FIG. 11B shows a further embodiment of a “Green Boiler” system comprising injection wells 380, heat delivery wells 381, monitor wells 382 and production wells 383. The production well 383 pumps oil, gas, brine and/or water 352. The production well 383 is equipped with an oscillator 368a and a jet pump 373, which aid in generating the pressure waves 385 that are used to increase oil recovery in the reservoir. A manifold 374a is also provided between the production well and a separator 353. The separator 353 separates the brine 351, gas 354 and the oil 355. A boiler and steam turbine or generator 360 is provided with oxygen from an oxygen/nitrogen separator 358, and is provided with the separated gas 354 and/or oil and with methane/Carbon Dioxide (CH₄/CO₂) 357 from a carbon dioxide/methane separator 356, receiving the separated gas 354. Using these components, the boiler 360 converts water from the steam turbine 362 into steam 361 and generates electricity for operations 364, electricity for sale on the energy market 384, and supplies electricity 365 to an electric heating cable 366 in the production well 383. CO2 359 from the oxygen/nitrogen separator 358 can also be added to the inlet flow to the boiler 360 as needed to control flame temperature without adding unwanted N₂ to the exhaust stream.

The exhaust of the boiler, turbine or generator 360 is provided to one or more heat exchangers 390 configured to heat water and/or brine. Separated brine 351 is mixed with water and additives 393 and pumped by a pump 392a to a heat exchanger 390, which heats the brine and outputs heated brine 370) to the injection well 380. Carbon dioxide 359, separated by the separator 356, is mixed with hot exhaust 363 from the heat exchanger 390, and compressed by a compressor 391. The compressed and heated CO₂ and exhaust gases 367 are supplied to a manifold 374b, and pumped into the injection well 380, which also incorporates an oscillator system 100 described herein to aid in creating pulsing pressure waves 385.

The heat delivery well 381 is provided with a manifold 374c. The heat delivery well 381 pumps via a pump 392b cooled water 372 to a heat exchanger 390, which outputs heated water 371. The heated water 371 is provided to the heat delivery well 381 to transfer heat into the well. As the heated water 371 transfers heat to the well, the water cools and the cooled water 372 is provided back to the heat exchanger 390 in a cyclical manner.

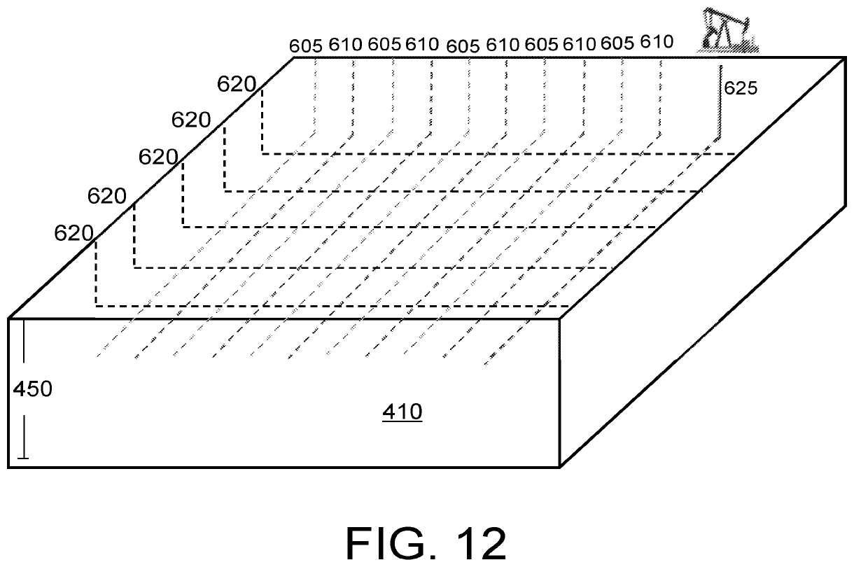

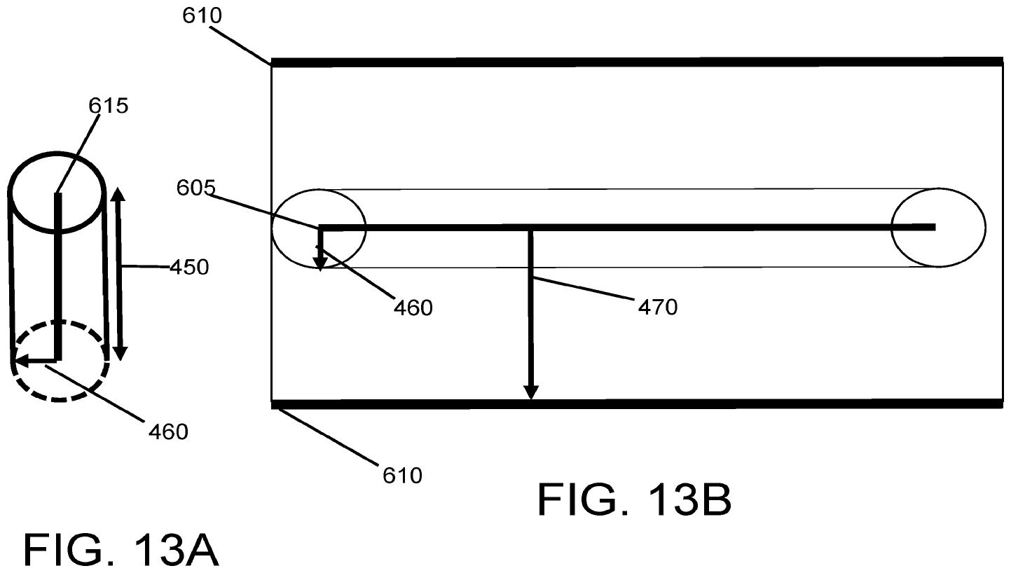

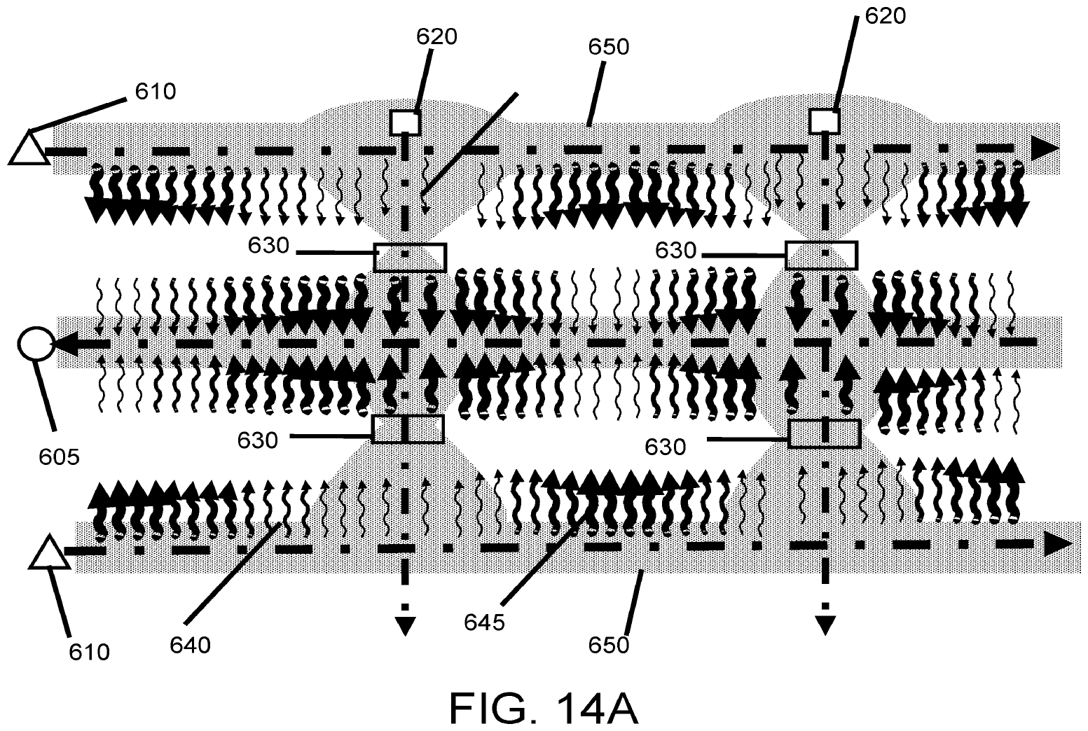

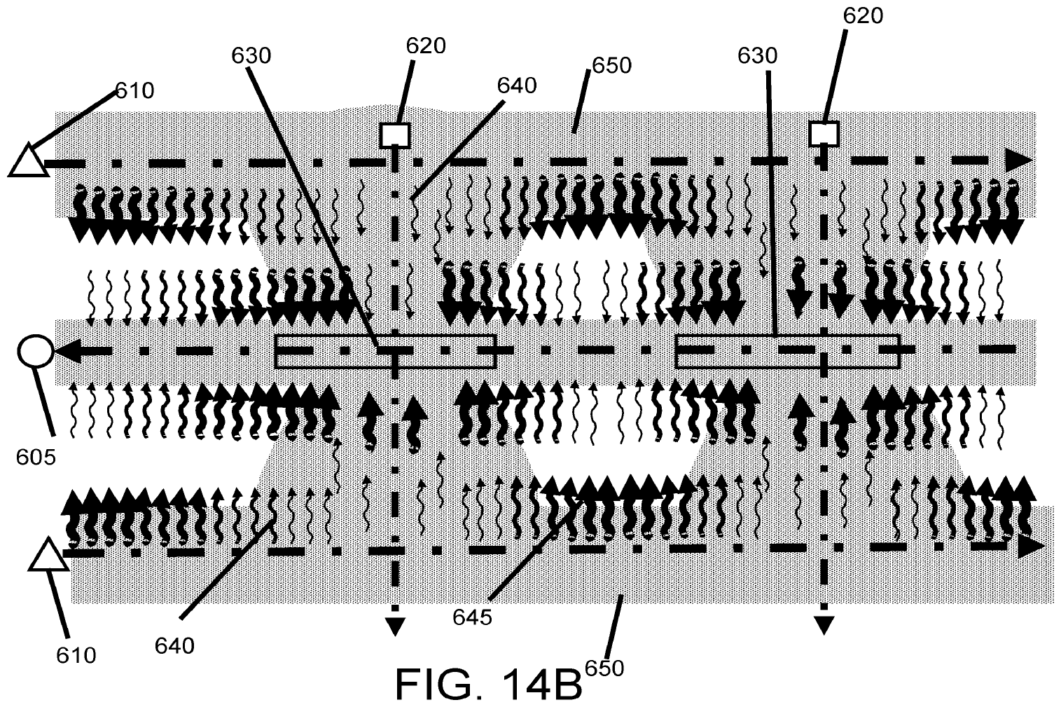

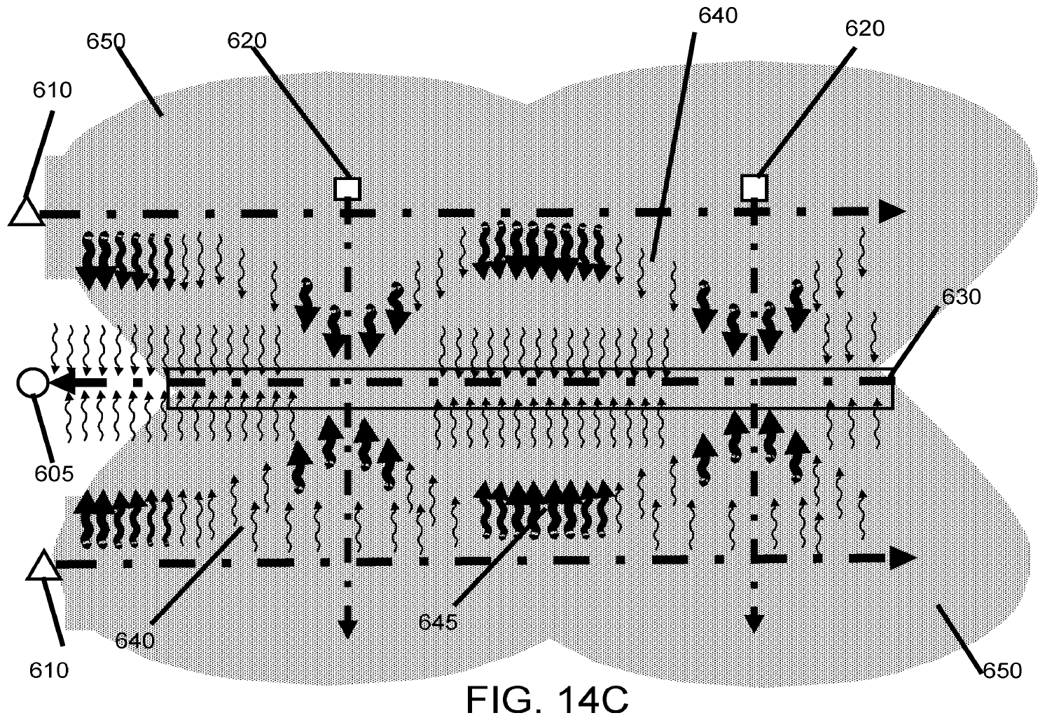

FIG. 12 shows a heat and fluid flow matrix in horizontal wells with induced high permeability. In the matrix shown in FIG. 12, there are adjacent and alternating producer wells 605 and injection wells 610 which run parallel in a first direction, as well as one or more optional depleted production well 635, and heat delivery wells 620 that run perpendicular in a second and perpendicular direction. FIGS. 13A and 13B show flow comparisons between a vertical production well 615 (FIG. 14A) and a horizontal production well 605 (FIG. 14B). In each of the examples, shown in FIGS. 13-14A, there is a pay zone 450 of two hundred feet and the horizontal well 605 pay zone is 2,640 feet. The normal drainage radius 460 for the horizontal production well 605 and vertical production well 615 is 75 feet. However, with pulsing of the production well 605 as described herein using the oscillator system 100, the drainage radius 470 is 525 feet. Additional properties of the flow comparison between a standard vertical production well 615, a standard production horizontal well, and a horizontal well 605 having the oscillator system 100 are shown below in Table 2.

TABLE 2
Comparison of Flows Between Horizontal and Vertical Production Wells

| | | | Sweep (Cubic feet) | Multiple of | Multiple of |
|---|---|---|---|---|---|
| | Pay Zone | Drainage | [Pay Zone · | Vertical | Horizontal |
| Well Type | (feet) | (Feet) | Drainage² · π] | Well | Well |
| Vertical Well 615 | 200 | 75 | 3,534,292 | 1 | 0.0758 |
| Horizontal well 605 | 2,640 | 75 | 46,652,651 | 13.2 | 1 |
| Horizontal Well 605 with | 2,640 | 525 | 2,285,979,894 | 647 | 49 |
| oscillator system 100 | | | | | |

As noted in Table 1, the volumetric sweep of a horizontal well 605 incorporating the oscillator system 100 is the equivalent of 647 vertical wells 615 and 49 horizontal wells 605 without the oscillator system 100, creating a corresponding increase in the amount of oil that can be collected in a given time period.

FIGS. 14A-14C show heat and oil delivery matrices over time. The oscillator system described herein is used in these applications to generate pressurized waves, as previously discussed. FIGS. 14A-14C show the growth of the heated region 650 over time (on one plane) and how the flow pattern is manipulated by having pressure gradients along the injection wells 610 and production wells 605. The horizontal heat pulsing waves 640 and 645 will travel in many directions and bounce off of the seal 601, the trap 602 and the higher viscosity oil, but will always travel in the direction of the production well 605. FIG. 14A shows the matrix arrangement after 10 days of implementation. FIG. 14B shows the matrix arrangement after fewer than 200 days of implementation. FIG. 14C shows the matrix arrangement once the oil flow has been maximized.

The system shown in FIGS. 14A-14C includes injector wells 610, heat delivery wells 620, and a producer well 605. The injector wells 610 and heat delivery well 620 are preferably ported, meaning that the pipes of the wells have ports spaced apart along the length of the pipe. For example, the ports can be separated by forty-two feet on each pipe. The size of the ports along the length of the pipes may vary in order to adjust the pressure of the waves created by the fluid exiting or entering the port, depending on whether the ports are in the injector well 610 or producer well 605. Ports having a smaller size or diameter create lower pressure waves, while ports having a larger size or diameter create higher pressure waves 645, as the amount of fluid that can exit the port of injector well 610 or enter the producer well 605 increases. As used in the Figures, a thinner wavy arrow corresponds to a low-pressure wave and lower corresponding flow rate, and a thicker wavy arrow 640 corresponds to a higher pressure wave and higher corresponding flow rate.

The combination of the injector wells 610, heat delivery wells 620 and producer well 605 as shown in the FIGS. 14A-14C reduces the viscosity of the oil or gas in the reservoir, creating low viscosity areas 650 and low viscosity flow paths 630. The low viscosity flow paths 630 push and pull oil and gas towards the producer well 605 with greater efficiency. Over time, the size of the low viscosity areas 650 and low viscosity flow paths 630 increases.

Additional applications of the oscillator system of the present application with respect to oil and gas extraction, in which the oscillator system creates pressurized waves include new oil and gas fields, operating oil and gas fields, depleted oil and gas fields, heavy crude, light crude, and gas.

The oscillator system 100 of the present application may also be used in applications for mixing fluids in tanks or other environments or structures.

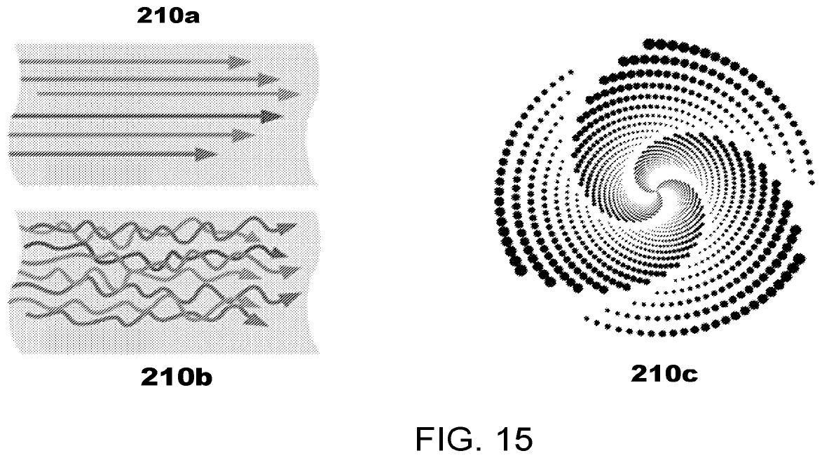

Flow modes for mixing or blending are shown in FIG. 15. A suspension is a heterogeneous mixture of a finely distributed solid in a liquid. The solid is not dissolved in the liquid, as is the case with a mixture of salt and water. The oscillator system 100 can be used for dissolving or non-dissolving applications. Different flow modes can be achieved by proper placement of the oscillators 101 and by varying pressure and frequencies. Flow modes include a laminar flow 210a with constructive interference, a turbulent flow 210b with modal interference, or a vortex flow 210c.

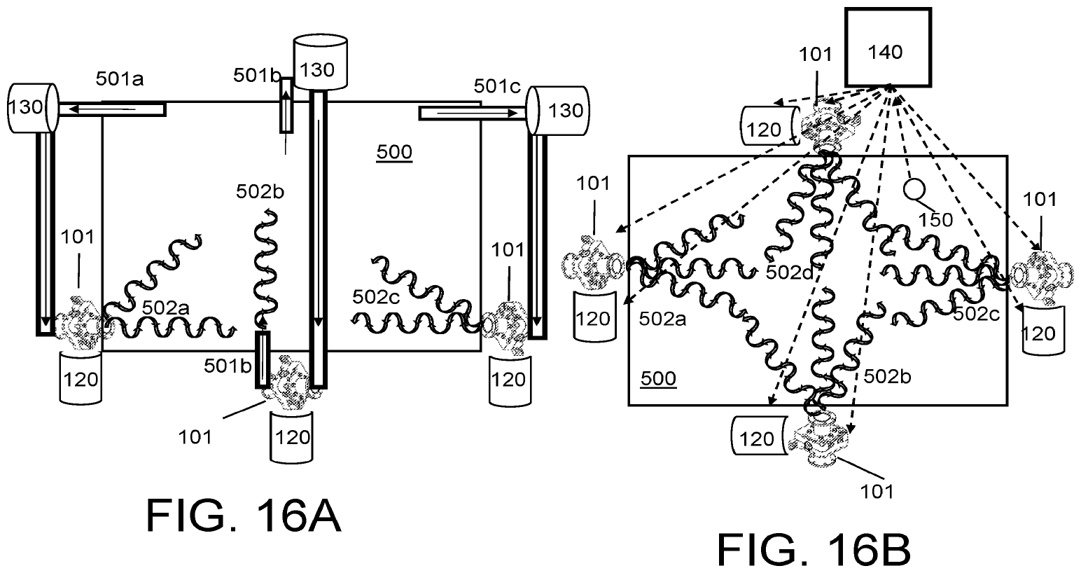

FIGS. 16A and 16B show a side view and a top view, respectively, of an application for mixing fluids in a tank 500 with exterior oscillators 101. Fluid is circulated throughout the tank 500 using a plurality of oscillators 101 located outside of the tank 500. A series of pumps 130 are positioned inside or outside of the tank 500, each of which is configured to take in fluid from within the tank 500 via a fluid line 501a, 501b, 501c, and pump the fluid towards a respective one of the oscillators 101, which reinjects the fluid 502a, 502b, 502c, 502d into the tank 500. The oscillators 101 are each provided with a motor 120 to rotate the oscillating valve 105 within so as to pulse the fluid 502a, 502b, 502c, 502d into the tank 500. The pulsing of the fluid 502a, 502b, 502c, 502d into the tank 500 causes additional turbulence within the tank 500 to enhance mixing of the fluid therein. When the pulsing waves meet they add and subtract causing mixing modes. By varying the frequencies of the various oscillators 101 with a control system 140 the system can thoroughly mix the fluids in the tank. The modal mixing effect is provided by having multiple oscillators 101, each operating at a different frequency.

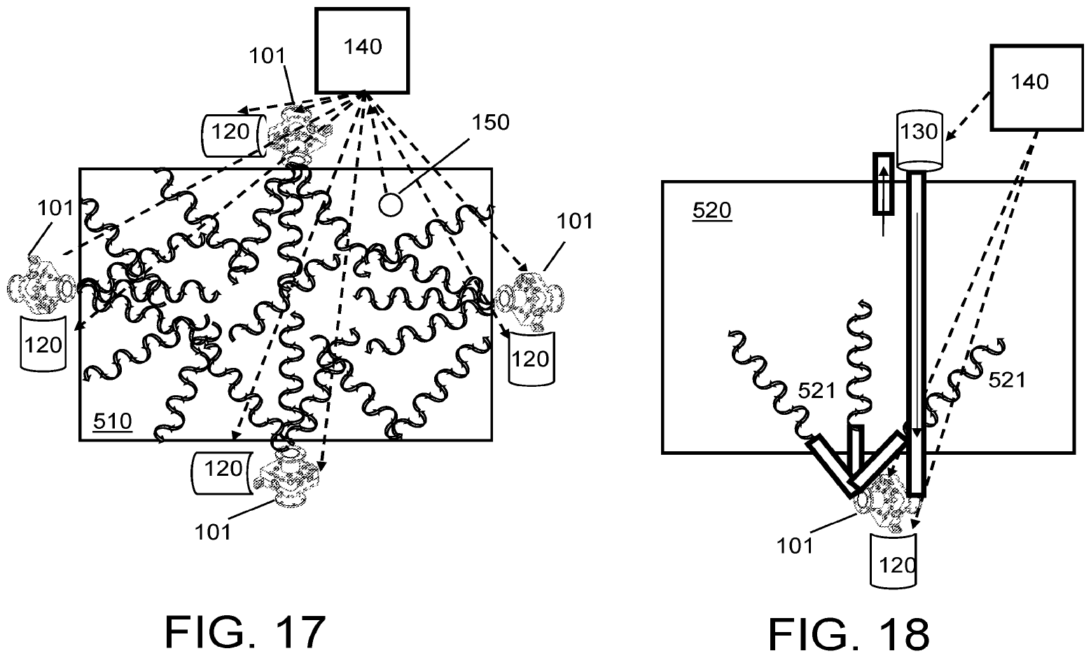

FIG. 17 shows results in the form of mode mixing for an application for mixing fluids in tanks 510 with exterior oscillators 101. In the wave theory of physics and engineering, a mode in a dynamical system is a standing wave state of excitation, in which all the components of the system will be affected sinusoidally at a fixed frequency associated with that mode. Because no real system can perfectly fit under the standing wave framework, the mode concept is taken as a general characterization of specific states of oscillation, thus treating the dynamic system in a linear fashion, in which linear superposition of states can be performed. Thus, depending on the design, generated waves bounce off the walls of the storage container completely mixing the fluids. FIG. 17 shows a top view of an application for mixing fluids in tanks 510 with exterior oscillators 101. Fluid is circulated throughout the tank 510 using a plurality of oscillators 101 located inside or outside of the tank 510. The pulsing of the fluid 502a, 502b, 502c, 502d within the tank 510 causes additional turbulence within the tank 510 to enhance mixing of the fluid therein.

FIG. 18 shows a side view of an application of the oscillator system 100 in mixing fluids in a small tank 520 using exterior oscillators 101. Fluid is circulated throughout the tank 520 using a one or more oscillators 101 located outside of the tank 520. A pump 130 is positioned inside or outside of the tank 520, which is configured to take in fluid from within the tank 520 via a fluid line and pump the fluid towards the oscillator 101, which reinjects the fluid 521 into the tank 520. The oscillator 101 is provided with a motor 120 to rotate the oscillating valve 105 within to pulse the fluid 521 into the tank 520. The pulsing of the fluid 521 into the tank 520 causes additional turbulence within the tank 520 to enhance mixing of the fluid therein. Additional chemicals or additives may be added to the fluid through the pump 130 in various embodiments.

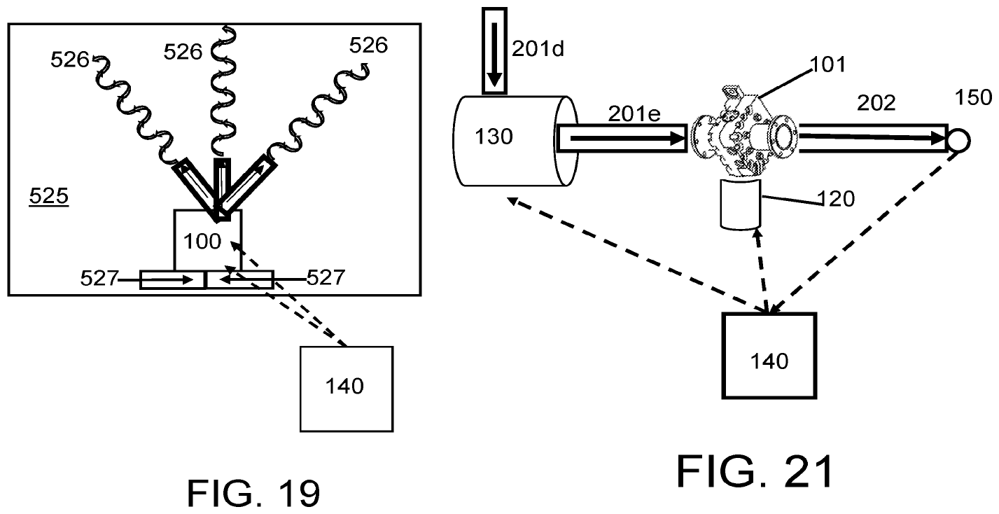

FIG. 19 shows a side view of an application of the oscillator system 100 in mixing fluids in small tanks 525 using one or more interior, submersible oscillator systems 100. Fluid is circulated throughout the tank 525 using one or more oscillator systems 100 submerged in the tank 525. Although not separately identified, the oscillator system 100 of FIG. 19 includes an oscillator 101, pump 130, and motor 120 as described elsewhere herein. The pump 130 of the submersible oscillator system 100 can be positioned inside or outside of the tank 525, which is configured to take in fluid from within the tank 520 via a fluid line 527 and pump the fluid towards the oscillator 101, which reinjects the fluid 526 into the tank 525. The oscillator 101 is provided with a motor 120 to rotate the oscillating valve 105 within to pulse the fluid 526 into the tank 525. The pulsing of the fluid 526 into the tank 525 causes additional turbulence within the tank 525 to enhance mixing of the fluid therein. Additional chemicals or additives may be added to the fluid through the pump 130 in various embodiments.

Examples of mixing applications incorporating the oscillator system 100 include chemical mixing to optimize dissolution, chemical mixing to optimize mixing with no dissolution, mixing to optimize particle or molecular homogeneous suspension, wastewater systems, and aeration.

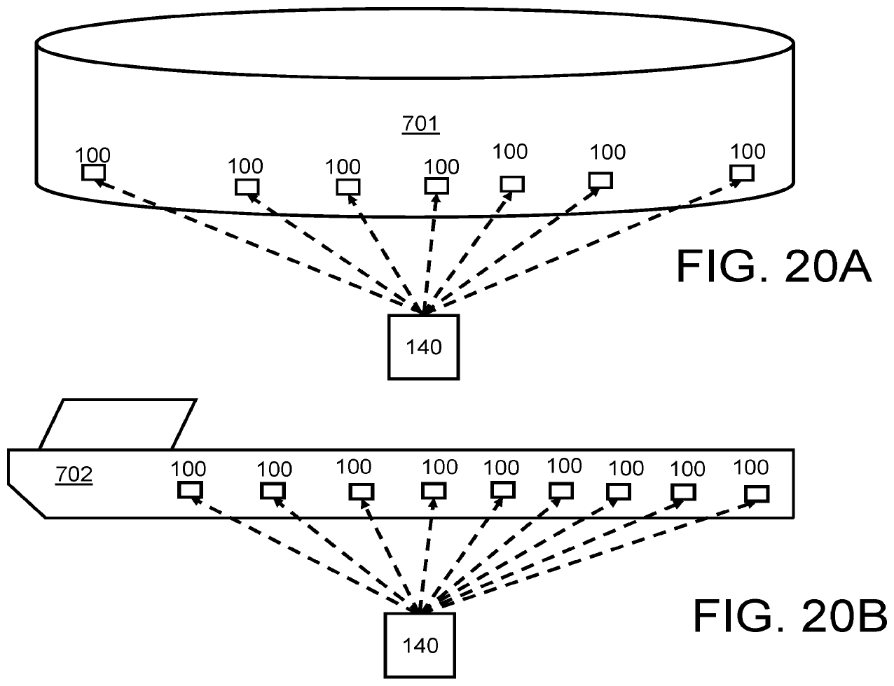

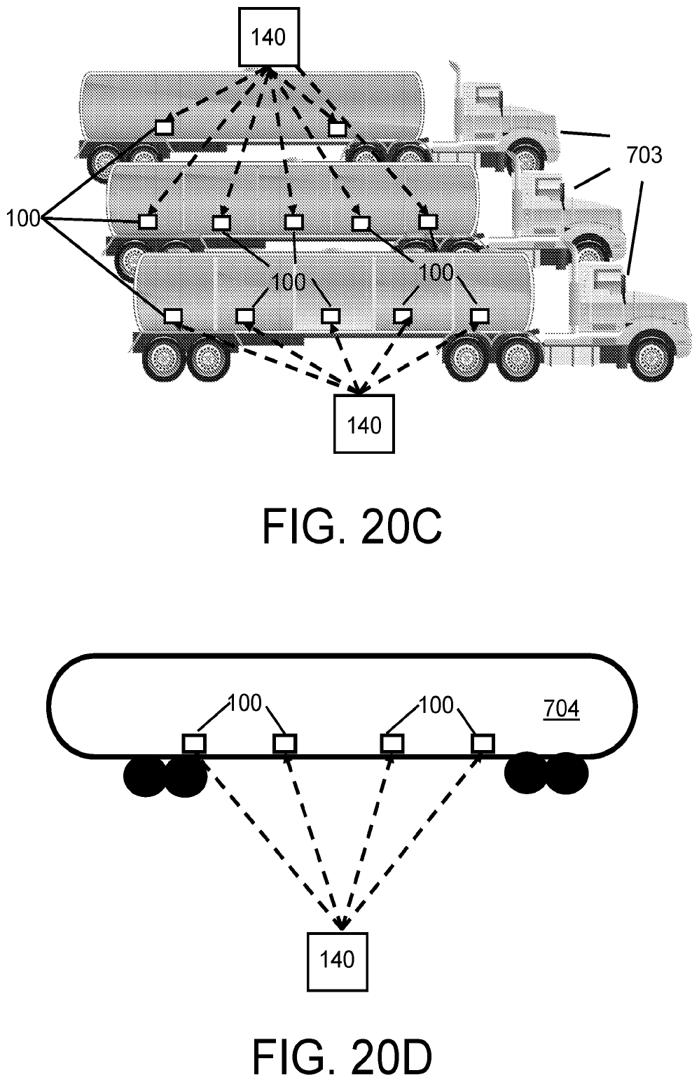

In one such example application, one or more oscillator system 100 can be to eliminate sludge accumulation with pressurized waves generated by the oscillator system 100. Such applications may include eliminating sludge buildup in storage tanks 701 (FIG. 20A), eliminating sludge buildup in oil tankers 702 (FIG. 20B), eliminating sludge buildup in oil trucks 703 (FIG. 20C), and eliminating sludge buildup in oil rail cars 704 (FIG. 20D), or any other containers storing oil or another viscous or liquid material that may form sludge buildup in the container if not properly agitated. The oscillator system 100 in these applications may operate similar to the tank mixing applications described previously. The oscillator system 100 circulates and agitates the oil in the different structures in order to prevent the oil from settling and forming sludge. In this application, the pulsing is keeping the sludge (particulates) suspended in the oil.

The oscillator system 100 may be used similarly in fluid containers that require aeration, to more evenly aerate the fluid container, or which may comprise a solid or liquid chemical or biological particulate that is preferably evenly dispersed throughout the fluid in the container. If the fluid container is left static, the gas or particulates may accumulate and settle at the top or bottom of the container. By circulating the fluid with the oscillator system 100, the fluid is moving within the container and the accumulation or settling of the gas or particulate matter can be reduced or avoided.

The oscillator system 100 may also be used in applications for optimizing fluid flow. Flow patterns in a fluid (gas or liquid) depend on three factors: the characteristics of the fluid, the speed of flow; and the shape of the solid surfaces. Three characteristics of the fluid are of special importance: viscosity, density, and compressibility. Viscosity is the amount of internal friction or resistance to flow. Flow patterns can be characterized as laminar or turbulent. The term laminar refers to streamlined flow in which a fluid glides along in layers that do not mix. The flow takes place in smooth continuous lines called streamlines. For fluids with very low viscosity, the fluid right next to the solid boundary sticks to the surface. This effect is known as the no-slip condition. Thus, however fast or easily the fluid away from the boundary may be moving, the fluid near the boundary has to slow down gradually and come to a complete stop exactly at the boundary. This effect is what causes drag. The flow pattern for a pipe is determined by the pump, pipe, valves, connectors, bends, corrosion, and viscosity of the fluid. FIG. 21 shows an example of optimizing of fluid flow by minimizing drag by oscillating the fluid. Fluid 201d is provided to a pump 130, which pumps the fluid 201e to the oscillator 101, which outputs a pulsed fluid 202. This may be utilized in water pipelines, oil pipelines, gas pipelines, chemical pipelines, water systems, or other fluid flow systems.

Oscillating valve 105 sizes typically range from 0.2 to 48 inches (0.5 cm to 121 cm). The valve housings 102 and oscillating valve 105 can be made of any suitable metal or plastic.

The pressure amplitude of the pulsed pumping wave that is required to loosen oil held in tightly held formations, or for other applications, can be determined in advance of operation. During operation, the control system can change the pulse amplitude in relatively small increments and then record the resulting extraction rate and composition of the oil. The energy used to extract the oil will be compared to the yield to maximize the efficiency of the process. This period for the modification of control parameters will be measured and adjusted as required. Perturbations of injected flow rate and temperature will also be imposed on the system and the oil extraction results assessed. A control algorithm can calculate the optimum injection rate and fluid temperature to optimize the net fluids extracted.

The control system can also vary the amount of heat used in the heat delivery wells. Though the imposed heat will produce higher heat saturation rates and temperatures, the resulting oil extraction rate must be balanced against the energy used to produce the heat used for this purpose. Large amounts of hot fluid will be available for use in the heat delivery wells, so a control algorithm can specify the optimum process parameters to maximize the net energy yield form the formation. It should be noted that this process can be repeated periodically (depending on the extraction rate of the fluids) to reassess the operation optimization, as these parameters will change significantly as the reservoir ages.

The control system 140 can control the system using the following parameters as inputs, each of which can be monitored by one or more sensors 150, where available in the particular system: CO₂ flow rate and temperature in the injection well flowing into the formation, including a flow rate and temperature of the CO₂ exhaust from a boiler, generator, and/or turbine and a flow rate and temperature of the CO₂ exhaust optional gas/oil turbine generator; water flow rate in the injection well flowing into the formation composed of water (brine) return flow from the oil/gas/brine separator via the boiler and any additives or additional water used in the injection flow; temperature of the flow rate in the injection well; pressure wave amplitude, mean pressure, and frequency in the injection well; power to the injection well pump/oscillator; pressure wave amplitude, mean pressure, and temperature at the monitoring well at several locations; flow rate and temperature of the production well fluid composed of crude oil, water/brine/additives and gas to the boiler and/or turbine/generator; pressure wave amplitude, mean pressure, and frequency in the production well; power to the production well pump/oscillator; water flow rate to the boiler; temperature of the water flow rate to the boiler; temperature of the water flow rate from the boiler; flow rate of additional gas to the green boiler and/or turbine; separated gas flow rate to the green boiler; separated gas flow rate to the turbine/generator; electricity generated by the turbine/generator; temperature and flow rate to the heat exchanger mixer; temperature and flow rate to the heat delivery well; temperature leaving the heat delivery well; electric power to the heat delivery well; and electric power to the production well.

Outputs from the control system controlling the system equipment can include: injection well oscillating pump maximum pressure; injection and production well oscillating pump frequency; production well oscillating pump minimum pressure; water/additive injection flow rate; CO₂ injection flow rate; heated water injection flow rate; heated water flow rate to the heat exchanger/mixer; heated water flow rate to the heat delivery well; electric power to the delivery well heaters; electric power to the production well heaters; position of the pressure access port field in the injection well; position of the pressure access port field in the production well; additional gas fuel input to the boiler and/or turbine/generator; gas flow rate to the boiler; and gas flow rate to the turbine/generator. The above listed inputs and outputs are not exhaustive. The specific parameters can be adjusted to the particular details of a given resource or system equipment configuration. The control system may comprise a non-transitory computer readable medium, such as a memory, and a processor configured to execute instructions for adjusting the components of the enhanced oil recovery system in response to feedback received from the monitoring well, pressure sensors and any other input receiving devices in the enhanced oil recovery system in communication with the control system.

It should be understood that, unless stated otherwise herein, any of the features, characteristics, alternatives or modifications described regarding a particular embodiment herein may also be applied, used, or incorporated with any other embodiment described herein. Also, the drawing herein is not drawn to scale. Although the invention has been described and illustrated with respect to exemplary embodiments thereof, the foregoing and various other additions and omissions may be made therein and thereto without departing from the spirit and scope of the present invention.

What is claimed:

1. An apparatus comprising:
a housing comprising:
an inlet port;
an outlet port; and
a chamber disposed in between the inlet port and the outlet port;
an oscillating valve comprising a valve body arranged inside of the chamber having an opening passing therethrough; and
an electric motor configured to rotate the oscillating valve in between a first alignment in which the opening through the valve body is aligned with and open between the inlet port and the outlet port of the housing, and a second alignment in which the opening through the valve body is not open to the inlet port and the outlet port of the housing;
wherein the oscillating valve is configured to allow a maximum fluid flow level through the apparatus when in the first alignment, a minimum fluid flow level through the apparatus when in the second alignment, and intermediate fluid flow levels when in between the first alignment and the second alignment; and
wherein oscillation between the first alignment and the second alignment creates pressure waves of fluid passing through the apparatus.

2. The apparatus according to claim 1, wherein the housing comprises a first housing member comprising the inlet port, and a second housing member comprising the outlet port, and the first housing member and the second housing member are secured to each other by a plurality of nuts and bolts.

3. The apparatus according to claim 1 or 2, further comprising: a pump configured to pump a fluid towards the inlet port of the apparatus.

4. The apparatus as in any one of claims 1-3, wherein the oscillating valve is a ball valve, further comprising a shaft extending from at least one side of the valve body; and wherein the electric motor is connected to the shaft and configured to rotate the oscillating valve in between a first alignment in which the opening through the valve body is aligned with and parallel to the inlet port and the outlet port of the housing, and a second alignment in which the opening through the valve body is perpendicular to the inlet port and the outlet port of the housing.

5. The apparatus as in any one of claims 1-4, wherein the electric motor is configured to rotate the oscillating valve 90° between the first alignment and the second alignment and is configured to reverse rotation 90° from the second alignment to the first alignment.

6. The apparatus as in any one of claims 1-5, wherein the electric motor is configured to rotate the oscillating valve 180° from the first alignment to the second alignment and further to the first alignment; and wherein the electric motor is configured to reverse rotation of the oscillating valve 180° from the first alignment to the second alignment and further to the first alignment.

7. The apparatus as in any one of claims 1-6, wherein the electric motor is configured to rotate the oscillating valve 360°.

8. The apparatus as in any one of claims 1-7, further comprising:
one or more sensors configured to monitor one or more conditions of an environment in which the apparatus is located, including one or more of flow rate, temperature, and pressure; and
a control system configured to control a speed and a frequency of rotation of the oscillating valve, based at least in part on input received by the control system from the one or more sensors.

9. The apparatus according to claim 8, wherein the control system is configured to control a frequency and amplitude of the pressure waves generated by the apparatus.

10. The apparatus according to claim 8 or 9, wherein the control system is configured to control fluid flow from a pump to the inlet port of the apparatus, based at least in part on input received by the control system from the one or more sensors.

11. The apparatus according to any one of claims 8-10, wherein the control system is configured to control a plurality of apparatuses in an environment and is configured to control the speed and the frequency of rotation of the oscillating valve of each of the plurality of apparatuses.

12. A system comprising:
one or more oscillation apparatus, each oscillation apparatus comprising:
a housing comprising:
an inlet port;
an outlet port; and
a chamber disposed in between the inlet port and the outlet port;
an oscillating valve comprising a valve body arranged inside of the chamber having an opening passing therethrough; and
an electric motor configured to rotate the oscillating valve in between a first alignment in which the opening through the valve body is aligned with and open between the inlet port and the outlet port of the housing, and a second alignment in which the opening through the valve body is not open to the inlet port and the outlet port of the housing; and
a pump configured to pump a fluid towards the inlet port of the oscillation apparatus;
wherein the oscillating valve is configured to allow a maximum fluid flow level through the oscillation apparatus when in the first alignment, a minimum fluid flow level through the oscillation apparatus when in the second alignment, and intermediate fluid flow levels when in between the first alignment and the second alignment; and
wherein rotation of the oscillating valve between the first alignment and the second alignment creates pressure waves of fluid passing through the oscillation apparatus.

13. The system according to claim 12, further comprising:
one or more sensors configured to monitor one or more conditions of an environment in which the oscillation apparatus is located, including one or more of flow rate, temperature, and pressure; and
a control system configured to control a speed and a frequency of rotation of the oscillating valve, based at least in part on an input received by the control system from the one or more sensors, and further configured to control fluid flow from the pump to the oscillation apparatus, based at least in part on the input received by the control system from the one or more sensors.

14. The system according to claim 13, wherein the one or more oscillation apparatus comprises a plurality of oscillation apparatuses, and wherein the control system is configured to control each of the plurality of oscillation apparatuses and is configured to control the speed and the frequency of rotation of the oscillating valve of each of the plurality of oscillation apparatuses.

15. The system according to any one of claims 12-14, further comprising:
a fluid line configured to provide fluid from the pump to the one or more oscillation apparatus, the fluid line comprising:
a first branch providing fluid from the pump in a flow path around the one or more oscillation apparatus
a second branch, branching off of the first branch, and providing the fluid from the pump to the inlet port of the one or more oscillation apparatus; and
a third branch providing fluid from the outlet port of the one or more oscillation apparatus into the first branch downstream of the second branch;
wherein the rotation of the oscillating valve of the one or more oscillation apparatus between the first alignment and the second alignment creates pressure waves of fluid flowing into the one or more oscillation apparatus through the first branch and flowing out of the one or more oscillation apparatus through the third branch.

16. The system according to any of claims 12-14, further comprising:
an underground hydrocarbon reservoir; and
a plurality of wells, including at least one fluid injection well and at least one hydrocarbon extraction well.

17. The system according to claim 16, wherein the pump is configured to pump fluid through the oscillating apparatus and into the at least one fluid injection well, and wherein the at least one fluid injection well injects the fluid into the underground hydrocarbon reservoir in a pulsed wave of increasing and decreasing pressure in order to increase recovery of the hydrocarbon in the underground hydrocarbon reservoir.

18. The system according to claim 16, wherein the pump is configured to pump fluid into the at least one fluid injection well and the fluid injection well comprises an oscillating apparatus submerged therein, and
wherein the at least one fluid injection well injects the fluid into the underground hydrocarbon reservoir in pulsed waves of increasing and decreasing pressure in order to increase recovery of hydrocarbon in the underground hydrocarbon reservoir.

19. The system according to claim 17 or 18, wherein the at least one hydrocarbon extraction well comprises an oscillation apparatus, which is configured to intake recovered hydrocarbon from the reservoir into the at least one hydrocarbon extraction well in a pulsed manner and to pump the recovered hydrocarbon aboveground.

20. The system according to any of claims 12-14, further comprising:
an underground hydrocarbon reservoir; and
at least one hydrocarbon extraction well comprising the one or more oscillation apparatus, which is configured to intake recovered hydrocarbon from the reservoir into the at least one hydrocarbon extraction well in a pulsed manner and to pump the recovered hydrocarbon aboveground.

21. The system according to claim 12, further comprising:
a plurality of fluid injection wells, each comprising the oscillation apparatus and configured to inject the fluid into the underground hydrocarbon reservoir in pulsed waves of increasing and decreasing pressure in order to increase recovery of hydrocarbon in the underground hydrocarbon reservoir;
a plurality of hydrocarbon extraction wells, each comprising an oscillation apparatus configured to intake recovered hydrocarbon from the underground hydrocarbon reservoir into the at least one hydrocarbon extraction well in a pulsed manner and to pump the recovered hydrocarbon aboveground;
one or more sensors configured to monitor one or more conditions of the underground hydrocarbon reservoir in which the apparatus is located, including one or more of hydrocarbon flow rate, temperature, and pressure; and
a control system configured to control a speed and a frequency of rotation of the oscillating valve of each of the oscillation apparatuses to control fluid flow through each of the oscillation apparatuses in combination to increase their collective effectiveness, based at least in part on input received by the control system from the one or more sensors.

22. The system according to any of claims 12-14, further comprising: a container comprising a fluid therein, wherein the one or more oscillation apparatus is configured to circulate the fluid within the container.

23. The system according to claim 22, wherein the container is a tank comprising the fluid, and the one or more oscillation apparatus comprise a plurality of oscillation apparatuses arranged external to the tank:
wherein the system comprises a plurality of pumps, each pump configured to pump fluid from within the tank to one of the plurality of oscillation apparatuses; and
wherein each of the plurality of oscillation apparatuses is configured to reinject the fluid into the tank in a pulsed manner to create turbulence and mixing of the fluid in the tank.

24. The system according to claim 22, wherein the container is a tank comprising the fluid, and the one or more oscillation apparatus comprise an oscillation apparatus arranged external to the tank;
wherein the pump is configured to pump fluid from within the tank to the oscillation apparatus; and
wherein the oscillation apparatuses is configured to reinject the fluid into the tank in a pulsed manner to create turbulence and mixing of the fluid in the tank.

25. The system according to claim 22, wherein the container is a tank comprising the fluid, and the one or more oscillation apparatus comprise a plurality of oscillation apparatuses arranged inside the tank; wherein each of the plurality of oscillation apparatuses is configured to intake the fluid from the tank and output the fluid back into the tank in a pulsed manner to create turbulence and mixing of the fluid in the tank.

26. The system according to claim 22, wherein the container is a tank comprising the fluid, and the one or more oscillation apparatus comprise an oscillation apparatus arranged inside the tank; wherein the oscillation apparatus is configured to intake the fluid from the tank and output the fluid back into the tank in a pulsed manner to create turbulence and mixing of the fluid in the tank.

27. The system according to claim 22, wherein the container is an oil storage tank and the fluid is oil, and each of the one or more oscillation apparatus is configured to intake the oil from the oil storage tank and output the oil back into the oil storage tank in a pulsed manner to create turbulence and mixing of the oil in the oil storage tank to reduce an accumulation of sludge inside the oil storage tank.

28. The system according to claim 22, wherein the container is a storage container of an aquatic oil tanker and the fluid is oil, and each of the one or more oscillation apparatus is configured to intake the oil from the oil tanker storage container and output the oil back into the oil tanker storage container in a pulsed manner to create turbulence and mixing of the oil in the oil tanker storage container to reduce an accumulation of sludge inside the oil tanker storage container.

29. The system according to claim 22, wherein the container is a storage container of an oil truck and the fluid is oil, and each of the one or more oscillation apparatus is configured to intake the oil from the oil truck storage container and output the oil back into the oil truck storage container in a pulsed manner to create turbulence and mixing of the oil in the oil truck storage container to reduce an accumulation of sludge inside the oil truck storage container.

30. The system according to claim 22, wherein the container is a storage container of an oil rail car and the fluid is oil, and each of the one or more oscillation apparatus is configured to intake the oil from the oil rail car storage container and output the oil back into the oil rail car storage container in a pulsed manner to create turbulence and mixing of the oil in the oil rail car storage container to reduce an accumulation of sludge inside the oil rail car storage container.

31. The system according to any one of claims 12-30, wherein the oscillating valve is a ball valve, further comprising a shaft extending from at least one side of the valve body; and wherein the electric motor is connected to the shaft and configured to rotate the oscillating valve in between a first alignment in which the opening through the valve body is aligned with and parallel to the inlet port and the outlet port of the housing, and a second alignment in which the opening through the valve body is perpendicular to the inlet port and the outlet port of the housing.

32. A method comprising:
pumping a fluid from a pump to an oscillation apparatus, the oscillation apparatus comprising:
a housing comprising: an inlet port; an outlet port; and a chamber disposed in between the inlet port and the outlet port;
an oscillating valve comprising: a valve body arranged inside of the chamber having an opening passing therethrough; and
an electric motor configured to rotate the valve body; and
while the fluid passes through the oscillation apparatus, oscillating the oscillating valve in between a first alignment in which the opening through the valve body is aligned with and parallel to the inlet port and the outlet port of the housing and a second alignment in which the opening through the valve body is perpendicular to the inlet port and the outlet port of the housing, wherein the oscillating valve is configured to allow a maximum fluid flow level through the oscillation apparatus when in the first alignment, a minimum fluid flow level through the oscillation apparatus when in the second alignment, and intermediate fluid flow levels when in between the first alignment and the second alignment; and wherein rotation of the oscillating valve between the first alignment and the second alignment creates pressure waves of fluid passing through the oscillation apparatus; and
outputting the pressure waves of fluid from the oscillation apparatus.

33. The method according to claim 32, further comprising:
sensing, by one or more sensors in an environment in which the oscillation apparatus is located, one or more conditions of the environment, including one or more of flow rate, temperature, and pressure;
providing a signal containing information about the one or more conditions of the environment to a control system in communication with the one or more sensors, the pump, and the electric motor; and
generating a control signal by a control system and transmitting the control signal to one or more of the pump or the electric motor configured to adjust a speed and a frequency of rotation of the oscillating valve and/or to adjust fluid flow from the pump, based at least in part on the signal provided by the one or more sensors.

34. The method according to claim 33, further comprising:
pumping the fluid from a plurality of pumps to a plurality of oscillation apparatuses each having an electric motor oscillating the oscillating valve while fluid passes through the respective oscillation apparatus;
outputting the pressure waves of fluid from the each of the plurality of oscillation apparatuses; and
generating a control signal by the control system and transmitting the control signal to the electric motor of at least one of the plurality of oscillation apparatuses to the configured to adjust a speed and a frequency of rotation of the oscillating valve, or to at least one of the plurality of pumps to adjust the fluid flow from the pump, based at least in part on the signal provided by the one or more sensors.

35. The method according to any one of claims 32-34, wherein the oscillation apparatus is in fluid communication with a fluid injection well of an underground hydrocarbon reservoir and outputting the pressure waves of fluid from the oscillation apparatus comprises outputting the pressure waves of fluid into the fluid injection well.

36. The method according to any one of claims 32-34, wherein the oscillation apparatus is submerged in a fluid injection well of an underground hydrocarbon reservoir and outputting the pressure waves of fluid from the oscillation apparatus comprises outputting the pressure waves of fluid into an underground hydrocarbon reservoir.

37. The method according to any one of claims 32-34, wherein the oscillation apparatus is provided in a hydrocarbon extraction well of an underground hydrocarbon reservoir and the method further comprises, intaking the fluid from the pump while oscillating the oscillating valve of the oscillation apparatus.

38. The method according to claim to any one of claims 32-34, further comprising mixing a fluid stored in a container by outputting the pressure waves of the fluid from the oscillation apparatus.

39. The method according to claim 38, wherein the oscillation apparatus is arranged external to the container and the method further comprises:
pumping the fluid from inside the container to the oscillation apparatus;
while the fluid passes through the oscillation apparatus, oscillating the oscillating valve of the oscillation apparatus; and
outputting the pressure waves of fluid from the oscillation apparatus into the container to create turbulence within the container.

40. The method according to claim 38, wherein the oscillation apparatus is submerged in the container and the method further comprises:
pumping the fluid to the oscillation apparatus;
while the fluid passes through the oscillation apparatus, oscillating the oscillating valve of the oscillation apparatus; and
outputting the pressure waves of fluid from the oscillation apparatus into the container to create turbulence within the container.

41. The method according to claim to any one of claims 32-34, further comprising: preventing settling of a particulate in the fluid and keeping the particulate in suspension by outputting the pressure waves of fluid from the oscillation apparatus into a container comprising the fluid and solid particulate therein.

42. The method according to claim 41, wherein the container comprises one or more of an oil storage tank, an aquatic oil storage tanker, an oil storage truck, or an oil storage rail car, and wherein the method further comprises reducing buildup of sludge particulate in the container by outputting the fluid in pressure waves of fluid from the oscillation apparatus and keeping sludge particulate in suspension.

43. The method according to claim 41, wherein the container comprises the fluid and a gas that is to be dispersed throughout the fluid, and wherein outputting the pressure waves of fluid from the oscillation apparatus into a container increases dispersion of the gas in the fluid throughout the container.

44. The method according to claim 41, wherein the container comprises the fluid and a chemical and/or biological particulate that is to be dispersed throughout the fluid, and wherein outputting the pressure waves of fluid from the oscillation apparatus into a container increases the dispersion of the chemical and/or biological particulate in the fluid throughout the container.
